(19) United States
(12) Patent Application Publication
(10) Pub. No.: US 2026/0365313 A1
(43) Pub. Date: Nov. 19, 2026

(54) TURBINE ENGINE CONTROL SYSTEM FOR A PROPULSION SYSTEM

(71) Applicant: General Electric Company, Evendale, OH (US)

(72) Inventors: Arthur W. Sibbach, Boxford, MA (US); Stefan Joseph Cafaro, Chapel Hill, NC (US)

(21) Appl. No.: 19/210,144

(22) Filed: May 16, 2025

(51) Int. Cl. B64D 31/04; B64D 27/33; F02C 9/42; G05G 1/04

(52) U.S. Cl. CPC B64D 31/04; B64D 27/33; F02C 9/42; G05G 1/04

(57) ABSTRACT

A turbine engine control system for a propulsion system including a first propulsor and a second propulsor. The turbine engine control system includes a single throttle lever having at least two degrees of freedom including a first degree of freedom and a second degree of freedom, and a controller. The controller receives a first position input from the single throttle lever in the first degree of freedom, controls a first control function of at least one of the first propulsor or the second propulsor based on the first position input, receives a second position input from the single throttle lever in the second degree of freedom, and controls a second control function of at least one of the first propulsor or the second propulsor based on the second position input.

### TECHNICAL FIELD

The present disclosure relates generally to turbine engines, and, particularly, to turbine engine control systems for propulsion systems of aircraft.

### BACKGROUND

Turbine engines, particularly, turboprop engines, for an aircraft generally include a propulsor, such as a propeller, and a turbo-engine arranged in flow communication with one another. The turbo-engine includes a compressor, a combustor, and a turbine section. Some turbine engines include an electric machine to provide power to the propulsor.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, or structurally similar elements.

FIG. 1 is a schematic partial cutaway view of a turbine engine, according to the present disclosure.

FIG. 2 is a schematic view of a propulsion system having a turbine engine control system, according to the present disclosure.

FIG. 3 is a schematic view of the propulsion system of FIG. 2 having the turbine engine control system, according to the present disclosure.

FIG. 4 is a schematic view of a propulsion system having a turbine engine control system, according to another embodiment.

FIG. 5 is a schematic view of a propulsion system having a turbine engine control system, according to another embodiment.

FIG. 6 is a detailed, schematic view of the turbine engine control system of FIG. 5, according to the present disclosure.

FIG. 7 is a schematic diagram of a turbine engine control system for a propulsion system, according to the present disclosure.

FIG. 8 is a schematic diagram of a single throttle lever of the turbine engine control system of FIG. 7, according to the present disclosure.

FIG. 9 is a flowchart of a method of controlling a propulsion system, according to the present disclosure.

FIG. 10 is an exemplary computing system, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle (e.g., an aircraft) with respect to a direction of travel. More particularly, forward and aft are used herein with reference to a direction of travel of the vehicle and a direction of propulsive thrust of the gas turbine engine.

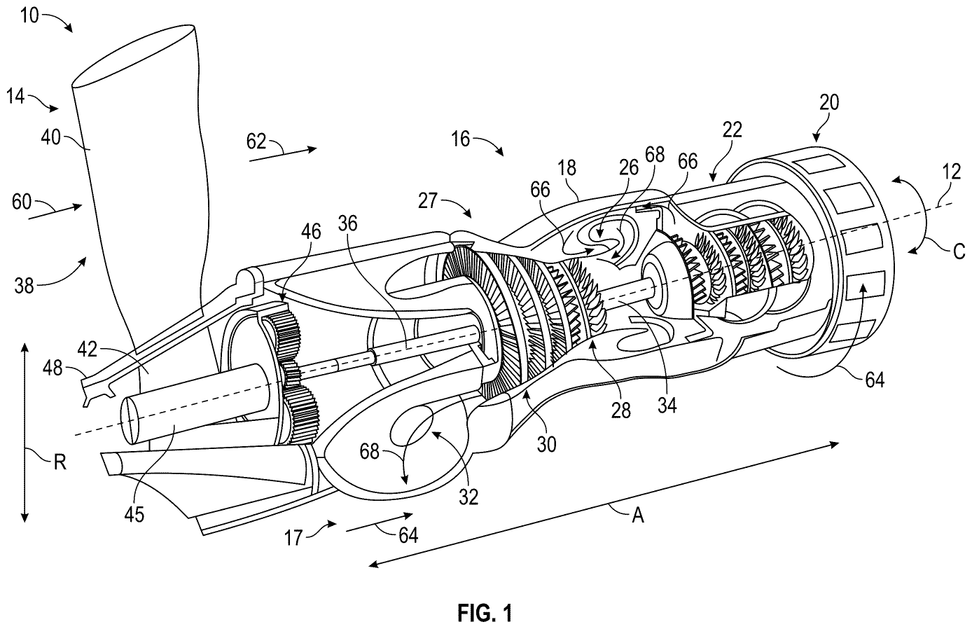

As used herein, “below” refers to a component being radially below another component in the orientation of the turbine engine shown in FIG. 1.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, “top” refers to a highest or uppermost point, portion, or surface of a component in the orientations shown in the figures.

As used herein, “bottom” refers to a lowest or lowermost point, portion, or surface of a component in the orientations shown in the figures.

As used herein, “remote” or a “remote component” means a component that is discrete from a first component such that the component is free from mechanical coupling (e.g., direct or indirect) to the first component. For example, a remote propulsor is a propulsor that is discrete from a first propulsor such that the remote propulsor can be mounted at a location on the aircraft that is different than the location of the first propulsor. The remote component may be communicatively or electrically coupled to the first component.

As used herein, a “propulsor” is a component that rotates and generates thrust. The propulsor can be a propeller. For example, the propulsor can be a propeller of a turboprop engine that is drivingly coupled to the turbo-engine such that rotation of the components of the turbo-engine causes the propulsor to rotate and to generate thrust. The propulsor can be an electric propulsor (e.g., propeller) that is remote from the turbine engine and is drivingly coupled to an electric machine such that the electric machine causes the propulsor to rotate and to generate thrust.

As used herein, a “degree of freedom” or “degrees of freedom” is a number of independent motions that are allowed by a single throttle lever. A position and an orientation of a rigid body (e.g., the single throttle lever) is defined by the number of degrees of freedom of the rigid body. For example, the single throttle lever has two or more components (e.g., two or more degrees of freedom) of translation such that the single throttle lever can be translated in each of the two or more degrees of freedom.

As used herein, the terms “low,” “mid” (or “mid-level”), and “high,” or their respective comparative degrees (e.g., “lower” and “higher”, where applicable), when used with compressor, combustor, turbine, shaft, propulsor, or turbofan engine components, each refers to relative pressures, relative speeds, relative temperatures, or relative power outputs within a turbine engine unless otherwise specified. For example, a “low-power” setting defines the turbine engine, or the combustor, configured to operate at a power output lower than a “high-power” setting of the turbine engine or the combustor, and a “mid-power” setting defines the turbine engine, or the combustor, configured to operate at a power output higher than the “low-power” setting and lower than the “high-power” setting. The terms “low,” “mid” (or “mid-level”) or “high” may additionally, or alternatively, be relative to minimum allowable speeds, pressures, or temperatures. The terms “low,” “mid” (or “mid-level”) or “high” may be understood to be relative to minimum or maximum allowable speeds, pressures, or temperatures relative to normal, desired, steady state, etc., operation of the turbine engine. A mission cycle for a turbine engine includes, for example, a low-power operation, a mid-power operation, and a high-power operation. Low-power operation includes, for example, engine start, idle, taxiing, and approach. Mid-power operation includes, for example, cruise. High-power operation includes, for example, takeoff and climb.

The various power levels of the turbofan engine are defined as a percentage of a sea level static (SLS) maximum engine rated thrust. Low-power operation includes, for example, less than thirty percent (30%) of the SLS maximum engine rated thrust of the turbine engine. Mid-power operation includes, for example, thirty percent (30%) to eighty-five percent (85%) of the SLS maximum engine rated thrust of the turbine engine. High-power operation includes, for example, greater than eighty-five percent (85%) of the SLS maximum engine rated thrust of the turbine engine. The values of the thrust for each of the low-power operation, the mid-power operation, and the high-power operation of the turbine engine are exemplary only, and other values of the thrust can be used to define the low-power operation, the mid-power operation, and the high-power operation.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and the claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

As noted above, turbine engines include a turbo-engine that provides power for rotating a propulsor (e.g., a propeller). The turbo-engine burns air and fuel to generate an exhaust gas flow that drives an aerodynamically coupled power turbine, or low-pressure turbine, that is further coupled to a set of propulsor blades of the propulsor via a propulsor shaft. In this sense, a speed of the turbo-engine indirectly affects a speed of the power turbine by providing torque to drive the propulsor, thus providing thrust.

The pitch of the propulsor blades can also be rotated on the propulsor shaft to provide additional thrust at the expense of increasing the torque demand of the turbine shaft. For instance, if the pitch of the propulsor blades is reduced, each propulsor blade rotates on the propulsor shaft such that the air resistance of the propulsor blade as the propulsor blade rotates about the propulsor shaft decreases, and, thus, reduces the torque demand for the propulsor shaft. In the instance when the turbo-engine speed is constant, the reduced torque demand of the propulsor results in an increased propulsor shaft rotational speed (RPM). Conversely, if the pitch of the propulsor blades is increased, each propulsor blade rotates on the propulsor shaft such that the air resistance of the propulsor blade as the propulsor blade rotates about the propulsor shaft increases, and, thus, increases the torque demand for the propulsor shaft. In the instance when the turbo-engine speed is constant, the increased torque demand of the propulsor results in a decreased propulsor shaft speed.

The present disclosure provides for a propulsion system including a turbine engine (e.g., a turboprop engine) with a propulsor, and a remote propulsor that is remote from the turbine engine. The turbine engine includes an electric machine and the remote propulsor includes an electric machine. In this way, the propulsor of the turbine engine can be powered electrically by the electric machine. Similarly, the remote propulsor can be powered electrically by the electric machine. In some embodiments, the remote propulsor is coupled to a remote turbine engine such that the remote turbine engine powers the remote propulsor.

Turbine engine control systems typically employ dual throttle levers used by the pilot to adjust, respectively, the turbo-engine speed demand, i.e., the speed of the turbo-engine, and the propulsor speed demand, e.g., via the pitch of the propulsor blades. In some instances, the dual throttle levers include a first throttle lever that controls the turbine engine and a second throttle lever that controls the remote propulsor. This dual-lever turbine engine control system allows for a variation of aircraft speed and torque demand during, for instance, takeoff, cruise, or reverse thrust operations. Typically, small turboprop aircraft include one lever for the core engine speed (power or fuel flow), and a second lever for controlling the pitch of the propulsor blades. The propulsor is designed to operate at a constant speed, so a pilot would need to first adjust the core engine speed to increase/decrease power, and then adjust the propulsor blade pitch to maintain the proper propulsor speed. The propulsor is driven by a free turbine downstream of the core engine, so when the core speed increases, if the propulsor pitch remains constant, then the propulsor speed increases. The pilot needs to change the pitch to counter the change in speed resulting from the core engine change. This results in an increased workload for the pilot.

Further, throttle levers typically move in a single degree of freedom (e.g., forward or aft) to control the thrust level output from the turbine engine or the propulsor. Moreover, different functions of the propulsion system (e.g., thrust level of the two propulsors, amount of thrust between the two propulsors, turbo-engine control or electric machine control, reverse thrust, etc.) typically require multiple levers or switches for controlling the multiple different functions. In this way, the complexity of the control system is further increased in addition to the complexities detailed above, and, thus, the workload for the pilot is further increased.

The present disclosure provides for an improved turbine engine control system that receives a single throttle lever input, and controls the turbine engine speed, the propulsor speed, and the propulsor pitch angle based on the single throttle lever input. The turbine engine control system can also control the remote propulsor speed and the remote propulsor pitch angle based on the single throttle lever input. Thus, the turbine engine control system can control the turbine engine and the remote propulsor based on the single throttle lever input. In this way, the propulsion system of the present disclosure requires only a single throttle lever to be actuated by the pilot to control both the turbine engine and the remote propulsor, thus, reducing pilot workload, allowing the pilot to better focus attention on other needs.

The present disclosure further provides for a single throttle lever having two or more degrees of freedom for controlling multiple control functions of the propulsion system. For example, the single throttle lever can control the thrust level of the propulsion system in a first degree of freedom (e.g., moving the single throttle lever forward or aft), and control a thrust level amount between the right propulsor and the left propulsor in a second degree of freedom (e.g., moving the single throttle lever left or right). The single throttle lever can also have a third degree of freedom (e.g., inward or outward) that controls a third function of the propulsion system, such as, for example, selecting forward thrust or reverse thrust, or selecting single propulsor control or multiple propulsor control. Accordingly, the single throttle lever of the present disclosure provides for controlling multiple functions of the propulsion system with a single device, and, thus reduces the overall complexity of the system and reduces pilot workload as compared to turbine engine control systems without the benefit of the present disclosure.

Referring now to the drawings, FIG. 1 is a schematic partial cutaway view of a turbine engine 10, according to an embodiment of the present disclosure. As shown in FIG. 1, the turbine engine 10 has a longitudinal centerline axis 12 and defines an axial direction A (extending parallel to the longitudinal centerline axis 12 provided for reference), a radial direction R that is normal to the axial direction A, and a circumferential direction C disposed about the axial direction A. In general, the turbine engine 10 is a turboprop engine that includes a propulsor section 14 and a turbo-engine 16 disposed downstream from the propulsor section 14. The propulsor section 14 is driven by the turbo-engine 16, as detailed further below.

The turbine engine 10 includes an air intake 17 aft of the propulsor section 14 and forward of the turbo-engine 16. The air intake 17 is a scoop inlet positioned radially outward from the longitudinal centerline axis 12. In the embodiment of FIG. 1, the air intake 17 is positioned at a radially bottom portion of the turbine engine 10 (e.g., below the longitudinal centerline axis 12 in the orientation shown in FIG. 1). For example, the air intake 17 is positioned below the propulsor section 14. The air intake 17 can be positioned at any radial position of the turbine engine 10 (e.g., on a side of the turbine engine 10 or on a radially top portion of the turbine engine 10). The air intake 17 directs air from the propulsor section 14 into the turbo-engine 16, as detailed further below.

The turbo-engine 16 includes, in serial flow relationship, a compressor 22, a combustor 26, and a turbine section 27. The turbo-engine 16 is substantially enclosed within an outer casing 18 that is substantially tubular and defines a radial inlet 20 at an axially aft end of the turbo-engine 16. As depicted schematically in FIG. 1, the combustor 26 is downstream of the compressor 22. The turbine section 27 is downstream of the combustor 26 and includes a high-pressure (HP) turbine 28 followed downstream by a low-pressure (LP) turbine 30. The turbo-engine 16 further includes an exhaust section 32 that is downstream of the turbine section 27, a high-pressure (HP) shaft 34 or a spool, and a low-pressure (LP) shaft 36. The HP shaft 34 drivingly connects the HP turbine 28 to the compressor 22. The HP turbine 28 and the compressor 22 rotate in unison through the HP shaft 34. The LP shaft 36 drivingly connects the LP turbine 30 to the propulsor section 14. The LP turbine 30 and the propulsor section 14 rotate in unison through the LP shaft 36. The compressor 22, the combustor 26, the turbine section 27, and the exhaust section 32 together define a core air flow path of the turbine engine 10.

The propulsor section 14 includes a propulsor 38 having a plurality of propulsor blades 40 (only one shown in FIG. 1) coupled to a disk 42 in a spaced apart manner. The propulsor 38 is a propeller. The propulsor blades 40 extend outwardly from the disk 42 generally along the radial direction R. The propulsor blades 40 and the disk 42 are together rotatable about the longitudinal centerline axis 12 via a propulsor shaft 45 that is powered by the LP shaft 36 across a power gearbox, also referred to as a gearbox assembly 46. In this way, the propulsor 38 is drivingly coupled to the turbo-engine 16 (e.g., to the LP turbine 30). The gearbox assembly 46 includes a plurality of gears for adjusting the rotational speed of the propulsor shaft 45 and, thus, the propulsor 38 relative to the LP shaft 36. In some embodiments, the propulsor 38 is a variable pitch propulsor such that each propulsor blade 40 is rotatable relative to the disk 42 about a pitch axis by virtue of the propulsor blades 40 being operatively coupled to an actuator configured to collectively vary the pitch of the propulsor blades 40 in unison. The disk 42 is covered by a rotatable propulsor hub 48 aerodynamically contoured to promote an airflow through the plurality of propulsor blades 40.

During operation of the turbine engine 10, a volume of air 60 passes through the propulsor blades 40 of the propulsor 38. As the volume of air 60 passes across the plurality of propulsor blades 40, a first portion of air, referred to as bypass air 62, is directed outside of the turbo-engine 16, and a second portion of air, referred to as core air 64, is directed into the air intake 17. The air intake 17 directs the core air 64 axially aftward towards the turbo-engine 16 and into the radial inlet 20.

The turbo-engine 16 is a reverse flow engine such that the core air 64 flows through the turbo-engine 16 from an aft end of the turbo-engine 16 to a forward end of the turbo-engine 16. In this way, the turbine engine 10 is referred to as a reverse flow turbine engine. The radial inlet 20 directs the core air 64 downstream to the compressor 22. In the compressor 22, a pressure of the core air 64 is increased, generating compressed air 66, and the compressed air 66 is routed into the combustor 26, where the compressed air 66 is mixed with fuel and burned to generate combustion gases 68. In the embodiment of FIG. 1, the combustor 26 is a reverse flow combustor such that the compressed air 66 flows from the compressor 22, around the combustor 26, and enters the combustor 26 at a forward end of the combustor 26. In this way, the compressed air 66 flows aftward within the combustor 26 and the combustion gases 68 are then directed from the combustor 26 forward to the turbine section 27.

In the turbine section 27, the combustion gases 68 are routed into the HP turbine 28 and expanded through the HP turbine 28 where a portion of thermal energy and kinetic energy from the combustion gases 68 is extracted via one or more stages of HP turbine stator vanes and HP turbine rotor blades that are coupled to the HP shaft 34. This causes the HP shaft 34 to rotate, supporting operation of the compressor 22 (self-sustaining cycle). In this way, the combustion gases 68 do work on the HP turbine 28. The combustion gases 68 are then routed into the LP turbine 30 and expanded through the LP turbine 30. Here, a second portion of the thermal energy and kinetic energy is extracted from the combustion gases 68 via one or more stages of LP turbine stator vanes and LP turbine rotor blades that are coupled to the LP shaft 36. This causes the LP shaft 36 to rotate, causing the propulsor 38 to rotate (self-sustaining cycle) via the gearbox assembly 46. In this way, the combustion gases 68 do work on the LP turbine 30. The combustion gases 68 are subsequently routed through the exhaust section 32 and out of the turbo-engine 16 to provide propulsive thrust.

The turbine engine 10 depicted in FIG. 1 is by way of example only. In other exemplary embodiments, the turbine engine 10 may have any other suitable configuration. For example, in other exemplary embodiments, the propulsor 38 may be configured in any other suitable manner (e.g., as a fixed pitch propulsor) and further may be supported using any other suitable propulsor frame configuration. Moreover, in other exemplary embodiments, any other suitable number or configuration of compressors, turbines, shafts, or a combination thereof may be provided. In certain exemplary embodiments, the turbine engine 10 of FIG. 1 may be utilized to drive a propeller of a helicopter, or may be utilized in aeroderivative applications. Additionally, in other exemplary embodiments, the turbine engine 10 may include any other suitable type of combustor, and may not include the exemplary reverse flow combustor depicted.

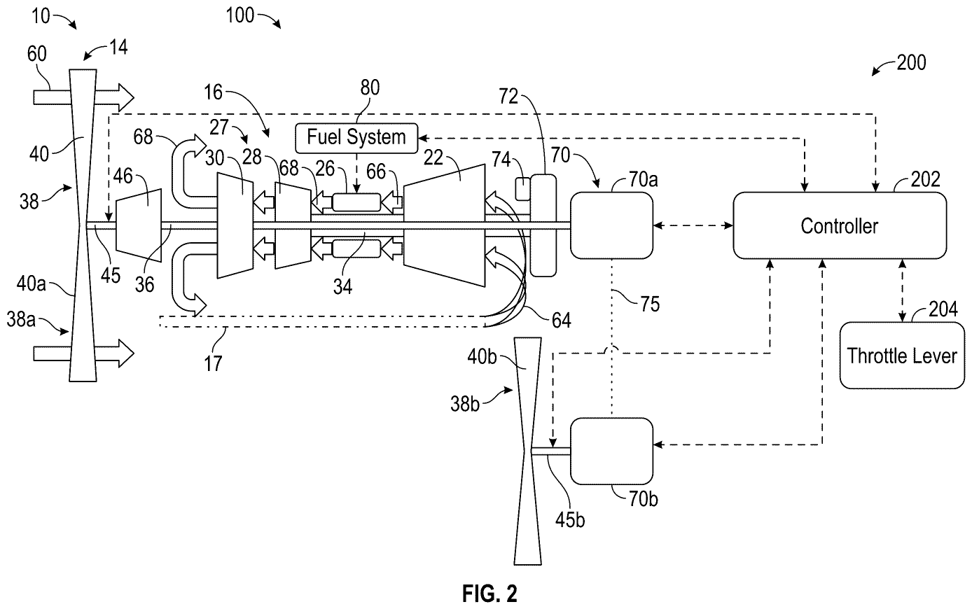

FIG. 2 is a schematic view of a propulsion system 100 having a turbine engine control system 200, according to the present disclosure. The propulsion system 100 includes the turbine engine 10. As shown in FIG. 2, the turbine engine 10 includes an electric machine 70 that is drivingly coupled to the LP shaft 36. In this way, the turbine engine 10 is a hybrid electric turbine engine. The electric machine 70 is positioned at an aft end of the turbine engine 10. The electric machine 70 may be positioned anywhere on the turbine engine 10. In some embodiments, the electric machine 70 is coupled to the LP shaft 36 via an electric machine gearbox (not shown in this view).

The electric machine 70 can be used in many different power configurations. In one form, the electric machine is configured to extract power from the LP shaft 36 when the electric machine 70 operates as a generator. The extraction of mechanical power from the LP shaft 36 and conversion to electric power can be used to charge an on-board power storage device such as a battery, or alternatively, to provide power to another electrical device (e.g., an electric motor, an electrical accessory on an aircraft, etc.). In other forms, the electric machine 70 can be used as a motor to provide power to the LP shaft 36 to supplement power extracted by the LP turbine 30 from the combustion gases 68. In these forms, the electric machine 70 can be configured to provide a minimum of 10% of supplemental thrust to the turbine engine 10, a minimum of 20% of supplemental thrust to the turbine engine 10, and up to 40% of supplemental thrust to the turbine engine 10 in various embodiments. In still other forms, the electric machine 70 can be configured to power to drive 100% of thrust from the propulsor section 14. A scenario in which the electric machine 70 provides all power to the propulsor section 14 can include shutdown of the turbine engine 10. In one non-limiting example of the turbine engine 10 being shut down, upon or near landing, the turbine engine 10 can be commanded to shut down and the electric machine 70 used to drive further propulsor thrust requirements, such as, for example, power when the propulsor section 14 is configured in reverse pitch to aid in slowing the aircraft.

A battery or other secondary power source (e.g., a fuel cell) can be used to provide power to the electric machine 70 when the electric machine 70 is operated as a motor. The supplementation of power by the electric machine 70 to the LP shaft 36 in this manner can be transitory or steady state, depending on the control requirements requested of the turbine engine 10. For example, in those operating conditions in which power output of the turbine engine 10 lags behind a commanded power, the electric machine 70 can provide near instantaneous supplemental power to the LP shaft 36 to provide on-condition power output until the turbine engine 10 achieves a steady state operating condition at the higher output power. In still further forms, the electric machine 70 can be operated as a motor in some portions of operation of the turbine engine 10, and as a generator in other portions of operation of the turbine engine 10, along the lines of any of the variations discussed herein.

The embodiment of FIG. 2 includes an accessory gearbox assembly (AGB) 72 located aft of the compressor 22 and is coupled to a starter motor 74. The starter motor 74 is coupled to the HP shaft 34 via the AGB 72 such that, during a start sequence of the turbine engine 10, the starter motor 74 can be used to impart rotational power via the AGB 72 to the HP shaft 34. In the illustrated embodiment, the AGB 72 is depicted as being co-axial with the HP shaft 34 and the LP shaft 36 (the AGB 72 is drivingly coupled to the HP shaft 34, but not otherwise drivingly coupled with the LP shaft 36). To provide such a coaxial relationship between the HP shaft 34 and the AGB 72, in one form, the AGB 72 is a planetary gear system in which the HP shaft 34 is coupled to a sun gear of the planetary gear system. In other forms, a central gear of the AGB 72 is coupled via one or more idler gears to the starter motor 74. Other forms are also contemplated to permit a co-axial relationship between the AGB 72 and the HP shaft 34. In other forms, however, the AGB 72 need not be co-axial with the HP shaft 34.

The turbine engine 10 also includes a fuel system 80 for providing the fuel to the combustor 26. For example, the fuel system 80 can include a fuel tank for storing the fuel, one or more fuel lines in flow communication with the fuel tank and the combustor 26, and a fuel pump for delivering the fuel from the fuel tank to the combustor 26 through the one or more fuel lines. The turbine engine 10 includes a first propulsor 38a having a plurality of first propulsor blades 40a and a first propulsor shaft 45a, and a first electric machine 70a.

The propulsion system 100 also includes a second propulsor 38b having a plurality of second propulsor blades 40b. The second propulsor 38b is remote (e.g., separate) from the turbine engine 10. The second propulsor 38b includes a second propulsor shaft 45b that is drivingly coupled to a second electric machine 70b. The second electric machine 70b is in electrical communication with the first electric machine 70a via a power conduit 75. In this way, the first electric machine 70a provides power to the second electric machine 70b via the power conduit 75. In some embodiments, the second electric machine 70b provides power to the first electric machine 70a via the power conduit 75. In some embodiments, the first electric machine 70a and the second electric machine 70b exchange power via a common energy storage device (e.g., one or more batteries). The second electric machine 70b is operated as a motor and drives the plurality of second propulsor blades 40b. The second electric machine 70b can be used to provide additional thrust output beyond that provided by the plurality of first propulsor blades 40a driven by the turbine engine 10.

The turbine engine control system 200 includes a controller 202 and a single input device, also referred to as a single throttle lever 204. The controller 202 is in two-way communication with the propulsion system 100 (e.g., the turbine engine 10, the second propulsor 38b, and the single throttle lever 204) for controlling aspects of the propulsion system 100 (e.g., the turbine engine 10, the second propulsor 38b, and the single throttle lever 204). The controller 202, or components thereof, may be located onboard the turbine engine 10, onboard the aircraft, or can be located remote from each of the turbine engine 10 and the aircraft (e.g., on the ground or on a remote propulsor). The controller 202 can be a Full Authority Digital Engine Control (FADEC) that controls aspects of the turbine engine 10.

The controller 202 may be a standalone controller or may be part of an engine controller to operate various systems of the turbine engine 10. In this embodiment, the controller 202 is a computing device having one or more processors and a memory. The one or more processors can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory can include one or more computer-readable media, including, but not limited to, non-transitory computer-readable media, a computer readable non-volatile medium (e.g., a flash memory), a RAM, a ROM, hard drives, flash drives, or other memory devices.

The memory can store information accessible by the one or more processors, including computer-readable instructions that can be executed by the one or more processors. The instructions can be any set of instructions or a sequence of instructions that, when executed by the one or more processors, cause the one or more processors and the controller 202 to perform operations. The controller 202 and, more specifically, the one or more processors, are programmed or configured to perform these operations, such as the operations discussed further below. In some embodiments, the instructions can be executed by the one or more processors to cause the one or more processors to complete any of the operations and functions for which the controller 202 is configured, as will be described further below. The instructions can be software written in any suitable programming language or can be implemented in hardware. Additionally, or alternatively, the instructions can be executed in logically or virtually separate threads on the processors. The memory can further store data that can be accessed by the one or more processors.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The single throttle lever 204 is a single, pilot-controllable, power control lever for controlling a power level of the turbine engine 10 and the second propulsor 38b. In this way, the turbine engine control system 200 includes a single throttle lever 204 (e.g., one throttle lever) for controlling aspects of both the turbine engine 10 and the second propulsor 38b. The single throttle lever 204 may be a pilot-accessible mechanical lever, for instance, located in a cockpit or a flight deck of an aircraft, that allows the pilot to provide input to control the turbine engine control system 200 by physically moving the single throttle lever 204 through a predetermined physical range of motion corresponding to the operation range of the turbine engine control system 200. The physical range of motion of the single throttle lever 204 may additionally include a first portion or a first range, wherein moving the single throttle lever 204 into the first portion corresponds to a forward movement of the aircraft, and a second portion or a second range, wherein moving the single throttle lever 204 into the second portion corresponds to a rearward movement of the aircraft.

The single throttle lever 204 can include a positional sensor that detects or converts the position of the single throttle lever 204, relative to the operational range of the single throttle lever 204 motion (in both the first position and the second position), and generate an output signal (e.g., a control signal) indicative of the position of the single throttle lever 204. For example, the single throttle lever 204 can include a lever anchored at a lever pivot, and rotatable over 88°, wherein the foremost 44° of rotation (relative to the pilot) may provide the first portion in the range of motion, while the rearmost 44° may provide the second portion, or reverse, range of motion. The positional sensor, in turn, generates a control signal that ranges from −44° to +44°. The 0° to 44° range defines the first position (corresponding to forward movement) and the 0° to −44° range defines the second position (corresponding to rearward movement). The single throttle lever 204 can be rotatable over any range, as desired, for generating a control signal for controlling the turbine engine 10 or portions thereof. While a lever is described for the single throttle lever 204, additional input devices allowing for pilot input can be used, such as a dial or a knob. Further, the single throttle lever 204 may be remote from the aircraft (e.g., remote controlled). Additionally, particular positions of the single throttle lever 204 may define different flight regimes, such as taxi, cruise, and takeoff. For example, a position of the single throttle lever 204 between 0° and 20° represents a taxi operation, a position of the single throttle lever 204 between 21° and 30° represents a cruise operation, and a position of the single throttle lever 204 at 44° represents a takeoff operation.

In operation, the turbine engine control system 200 receives an input (e.g., the control signal) from the single throttle lever 204 and controls the turbine engine 10 (e.g., at least one of the turbo-engine 16 or the first propulsor 38a) and the second propulsor 38b based on the input from the single throttle lever 204. In particular, the turbine engine control system 200 controls a rotational speed of the turbo-engine 16 and at least one of a rotational speed of the first propulsor 38a, a pitch of the plurality of first propulsor blades 40a, or a torque of the first propulsor 38a. The turbine engine control system 200 also controls at least one of a rotational speed of the second propulsor 38b, a pitch of the plurality of second propulsor blades 40b, or a torque of the second propulsor 38b. In some embodiments, the turbine engine control system 200 controls the fuel system 80 to increase or to decrease a fuel flow rate of the fuel to the combustor 26 to control the rotational speed of the turbo-engine 16. In some embodiments, the turbine engine control system 200 controls the first electric machine 70a to control the first propulsor 38a. For example, the controller 202 controls the first electric machine 70a and the second electric machine 70b to increase or to decrease an amount of power from the first electric machine 70a to the first propulsor 38a for controlling the rotational speed or the torque of the first propulsor 38a. The turbine engine control system 200 similarly controls the second electric machine 70b to control the second propulsor 38b.

To control the turbine engine 10, the first propulsor 38a, and the second propulsor 38b, the controller 202 receives a position input from the single throttle lever 204. The controller 202 then converts the position input into at least one of a turbine engine setting or a first propulsor setting, and a second propulsor setting. The turbine engine setting includes a rotational speed of the turbo-engine 16. The first propulsor setting includes at least one of a rotational speed of the first propulsor 38a, a pitch of the plurality of first propulsor blades 40a, or a torque of the first propulsor 38a. The second propulsor setting includes at least one of a rotational speed of the second propulsor 38b, a pitch of the plurality of second propulsor blades 40b, or a torque of the second propulsor 38b. The controller 202 then controls at least one of a rotational speed of the turbo-engine 16, a rotational speed of the first propulsor 38a, a pitch of the plurality of first propulsor blades 40a, or a torque of the first propulsor 38a, and at least one of a rotational speed of the second propulsor 38b, a pitch of the plurality of second propulsor blades 40b, or a torque of the second propulsor 38b based on the at least one of the turbine engine setting or the first propulsor setting, and the second propulsor setting. For example, the controller 202 controls the rotational speed of the turbo-engine 16 based on the turbine engine setting. The controller 202 controls at least one of the rotational speed of the first propulsor 38a, the pitch of the plurality of first propulsor blades 40a, or the torque of the first propulsor 38a based on the first propulsor setting. The controller 202 controls at least one of the rotational speed of the second propulsor 38b, the pitch of the plurality of second propulsor blades 40b, or the torque of the second propulsor 38b based on the second propulsor setting.

In one embodiment, the controller 202 determines the turbine engine setting, the first propulsor setting, and the second propulsor setting based on one or more speed maps. For example, the controller 202 includes a turbo-engine speed map, a first propulsor speed map, and a second propulsor speed map. The turbine engine speed map, the first propulsor speed map, and the second propulsor speed map each operates as a demand map, or a look-up table, and may be configured with predetermined profiles, dynamic profiles, or setting values, for instance, via an implementation of an algorithm. In particular, the speed maps correlate various position inputs from the single throttle lever 204 to the turbine engine setting, the first propulsor setting, and the second propulsor setting. Each of the turbine engine speed map, the first propulsor speed map, and the second propulsor speed map may additionally define limitations to aircraft operation. For example, the turbine engine speed map, the first propulsor speed map, and the second propulsor speed map may provide limited maximum or minimum thrust or speed utilized during taxi, cruise, or takeoff. In another example, the turbine engine speed map, the first propulsor speed map, and the second propulsor speed map may define a maximum or a minimum turbine engine 10 speed, first propulsor 38a speed and pitch, or second propulsor 38b speed and pitch utilized during ground idle. In another example, the first propulsor speed map and the second propulsor speed map may define a constant propulsor speed with an adjusting propulsor blade pitch value. Alternatively, the first propulsor speed map and the second propulsor speed map may provide a constant propulsor blade pitch value with a varying propulsor speed. In yet another example, the first propulsor speed map and the second propulsor speed map may provide a varied speed or a varied pitch in either a forward thrust operation or a reverse thrust operation. In even yet another example, the first propulsor speed map and the second propulsor speed map may employ multiple maps, wherein, for instance, a forward control signal utilizes a forward propulsor speed map while a reverse control signal utilizes a reverse propulsor speed map. In even yet another example, the turbine engine speed map, the first propulsor speed map, and the second propulsor speed map may be configured to prevent excess or undesirable temperature conditions on the turbo-engine 16, and over-torque or overspeed on the first propulsor 38a and the second propulsor 38b, respectively.

The turbine engine speed map, the first propulsor speed map, and the second propulsor speed map may additionally define profiles of operation, wherein, for example, the turbine engine speed map, the first propulsor speed map, and the second propulsor speed map are configured to provide setting values for optimal aircraft efficiency, turbine engine efficiency, or propulsor efficiency. For example, the first propulsor speed map and the second propulsor speed map may be configured to provide an optimized propulsor speed for a corresponding turbine engine speed map value. The optimized profiles may additionally take into account additional sensor values, for instance, relating to air speed, altitude, etc., to provide an optimal turbine engine 10 speed, an optimal first propulsor 38a speed and first propulsor blade 40a pitch, and an optimal second propulsor 38b speed and second propulsor blade 40b pitch, for example, for an optimized fuel efficiency profile, an optimized thrust profile, an optimized audible profile (i.e., by controlling pitch of the first propulsor blades 40a or the second propulsor blades 40b), or an optimized flight time efficiency profile. The optimization profiles may be further delineated by a given control signal from the single throttle lever 204. The optimized profiles may be user-selectable by the pilot.

Additionally, or alternatively, at least one of the turbine engine speed map, the first propulsor speed map, or the second propulsor speed map may be configured to provide for a linear thrust response, that is, a linear thrust relative to the position of the single throttle lever 204. The thrust response may be linear in a forward thrust operation or a reverse thrust operation. In this sense, “linear” may refer to the overall thrust that, as explained above, is affected by the configurations of the turbine engine 10, the first propulsor 38a, the first propulsor blades 40a, the second propulsor 38b, and the second propulsor blades 40b. Thus, a linear thrust may not be proportionally related to, for example, only a change in one component (e.g., the turbo-engine 16, the first propulsor 38a, the first propulsor blades 40a, the second propulsor 38b, or the second propulsor blades 40b) of the configuration. Additionally, “linear” may define a maximum allowable change in setting values, regardless of how much change or how quickly a change was requested via the single throttle lever 204. In this instance, a “linear” thrust response may only allow for a 1% increase in turbine engine power per second. In another sense, “linear” may define a feedback response from a perspective of the pilot. For instance, a pilot may define a feeling of “linear” thrust response as, for example, a 1% increase in thrust for one second, followed by a 2% increase in thrust for three seconds. Further, this thrust response may be different depending on the status, or flight regime, of the aircraft (e.g., taxi, cruise, takeoff, etc.).

Each of the turbine engine speed map, the first propulsor speed map, or the second propulsor speed map receives the control signal from the single throttle lever 204, and the controller 202 determines the turbine engine setting (e.g., the turbo-engine setting and the first propulsor setting) and the second propulsor setting in response to, or as a function of, the received input. In some embodiments, the controller 202 determines a desired turbine engine setting (e.g., a desired turbo-engine setting and a desired first propulsor setting) and a desired second propulsor setting based on the received input from the single throttle lever 204. The controller 202 then compares the desired turbine engine setting and the desired second propulsor setting to an actual turbine engine setting and an actual second propulsor setting. For example, the controller 202 determines the actual rotational speed of the turbo-engine 16, the actual rotational speed of the first propulsor 38a and the second propulsor 38b, the actual pitch of the first propulsor blades 40a and the second propulsor blades 40b, and the actual torque of the first propulsor 38a and the second propulsor 38b. The controller 202 then controls the turbo-engine 16, the first propulsor 38a, and the second propulsor 38b based on the comparison. For example, to speed up the first propulsor 38a or the second propulsor 38b, the controller 202 generates a positive value that, in turn, decreases the first propulsor 38a pitch or the second propulsor 38b pitch, thus increasing the rotational speed of the first propulsor 38a or the second propulsor 38b. Likewise, to slow down the first propulsor 38a or the second propulsor 38b, the controller 202 generates a negative value that, in turn, increases the first propulsor 38a pitch or the second propulsor 38b pitch, thus decreasing the rotational speed of the first propulsor 38a or the second propulsor 38b. In instances when the control signal is static, the operation of speeding up and/or slowing down of the first propulsor 38a or the second propulsor 38b will ultimately equalize at a point wherein the controller 202 generates a neutral value, at which the pitch of the first propulsor 38a or the second propulsor 38b is neither increased nor decreased. The controller 202 can similarly control the turbo-engine 16, the first propulsor 38a, and the second propulsor 38b during a reverse thrust operation.

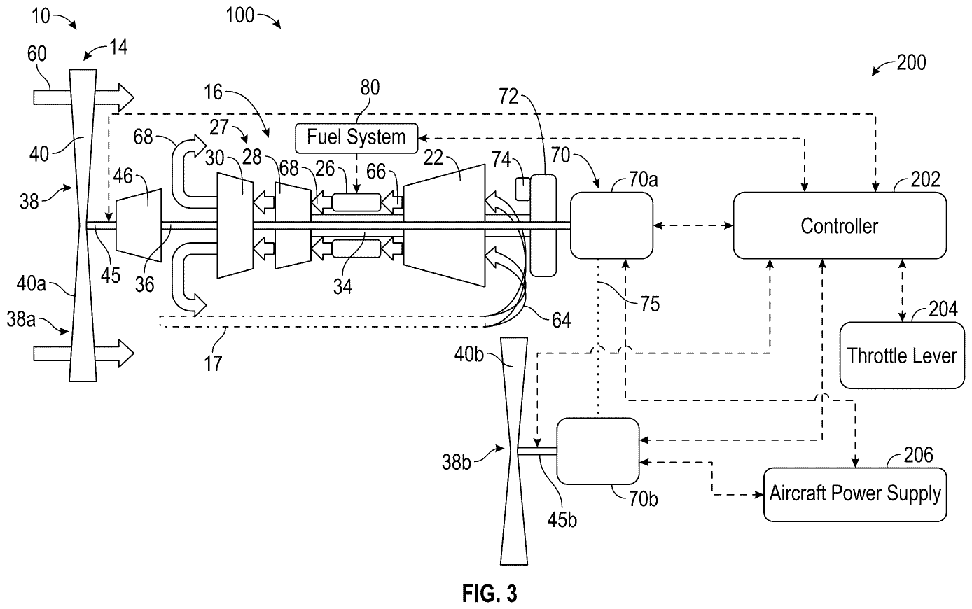

FIG. 3 is a schematic view of the propulsion system 100 having the turbine engine control system 200, according to the present disclosure. As shown in FIG. 3, the turbine engine control system 200 further includes an aircraft power supply 206 for powering the second electric machine 70b. The aircraft power supply 206 includes at least one of a fuel cell, one or more batteries, or an auxiliary power unit (APU) of the aircraft. The aircraft power supply 206 can also power the first electric machine 70a. In some embodiments, the second electric machine 70b receives power from both the first electric machine 70a and the aircraft power supply 206. For example, the aircraft power supply 206 supplies the power during takeoff or landing, and the first electric machine 70a supplies the power during cruise.

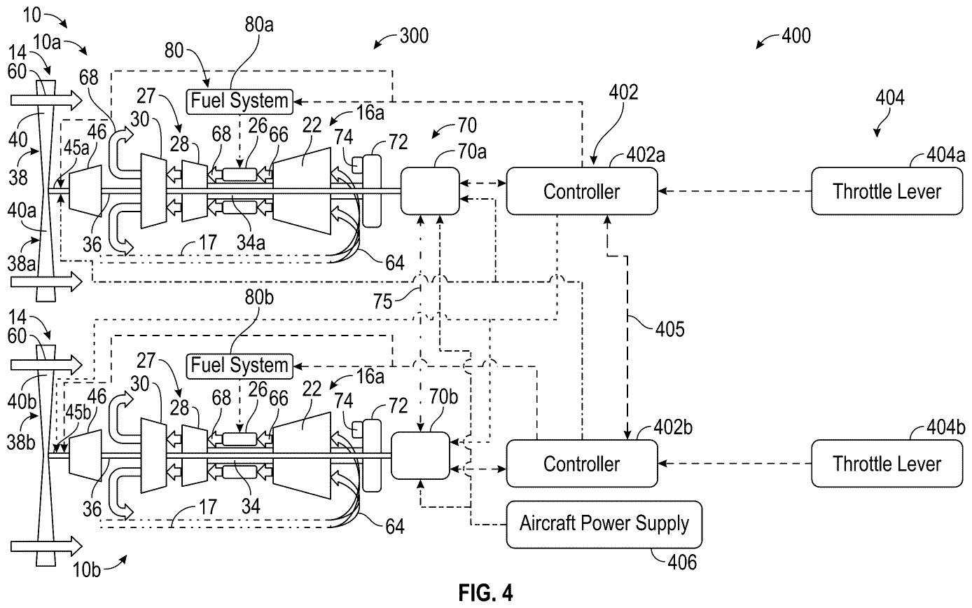

FIG. 4 is a schematic view of a propulsion system 300 having a turbine engine control system 400, according to another embodiment. The turbine engine control system 400 is substantially similar to the turbine engine control system 200 shown in FIGS. 2 and 3. The same or similar reference numerals will be used for components of the turbine engine control system 400 that are the same as or similar to the components of the turbine engine control system 200 discussed above, unless stated otherwise. The description of these components above also applies to this embodiment, and a detailed description of these components is omitted here.

The propulsion system 300 includes a plurality of turbine engines 10, including a first turbine engine 10a and a second turbine engine 10b. The first turbine engine 10a has a first turbo-engine 16a and the second turbine engine 10b has a second turbo-engine 16b. The second propulsor 38b is drivingly coupled to the second turbo-engine 16b (e.g., via the LP shaft 36 of the second turbo-engine 16b) such that the second turbine engine 10b includes the second propulsor 38b. In this way, the second turbo-engine 16b powers the second propulsor 38b. The first turbine engine 10a includes a first fuel system 80a and the second turbine engine 10b includes a second fuel system 80b.

The turbine engine control system 400 includes one or more controllers 402 and one or more single throttle levers 404, including a first single throttle lever 404a and a second single throttle lever 404b. The turbine engine control system 400 also includes an aircraft power supply 406. The one or more controllers 402 include a first controller 402a for controlling the first turbine engine 10a and a second controller 402b for controlling the second turbine engine 10b. The first single throttle lever 404a is in communication with the first controller 402a. The second single throttle lever 404b is in communication with the second controller 402b. In this way, the first single throttle lever 404a controls the first turbine engine 10a and the second single throttle lever 404b controls the second turbine engine 10b. The turbine engine control system 400 also includes a data communication bus 405 for providing communication between the first controller 402a and the second controller 402b. The data communication bus 405 can include wired communication (e.g., a wire harness, an aircraft data bus, such as ARINC, etc.) or wireless communication (e.g., Wi-Fi®, Bluetooth®, cellular communication, such as 5G, etc.). In this way, the first controller 402a can control aspects of the second turbine engine 10b and the second controller 402b can control aspects of the first turbine engine 10a, under certain operating conditions, as detailed further below.

In operation, the turbine engine control system 400 is substantially similar to the turbine engine control system 200 of FIG. 2. The first controller 402a controls the first turbine engine 10a (e.g., the first turbo-engine 16a and the first propulsor 38a) based on the input from the first single throttle lever 404a. The second controller 402b controls the second turbine engine 10b (e.g., the second turbo-engine 16b and the second propulsor 38b) based on the input from the second single throttle lever 404b.

The first controller 402a receives operating mode signals indicative of an operating mode of the second turbine engine 10b from the second controller 402b. In some instances, the second turbine engine 10b enters a standby operating mode or a failure mode occurs. For example, the rotational speed of the second turbo-engine 16b reduces to less than a speed threshold for the current flight condition, or the first controller 402a loses communication with the second controller 402b. The standby operating mode can comprise at least one of a normal idling mode, an assisted idling mode, a banking mode, or a stopping mode. The normal idling mode occurs when the combustor 26 is operating (e.g., ignited) and the LP shaft 36 rotates at a rotational speed in a range of 45% to 70% of a nominal speed of the LP shaft 36. The nominal speed is a speed of the LP shaft 36 at a maximum cruise condition of the second turbine engine 10b (or the first turbine engine 10a). The assisted idling mode occurs when the combustor 26 is operating and the LP shaft 36 rotates in a mechanically assisted manner (e.g., via the starter motor 74) at a rotational speed in a range of 20% to 60% of the nominal speed. The banking mode occurs when the combustor 26 is shut down (e.g., extinguished) and the LP shaft 36 rotates in a mechanically assisted manner at a rotational speed in a range of 5% to 30% of the nominal speed. The stopping mode occurs when the combustor 26 is shut down and the LP shaft 36 stops rotating or windmills due to airflow through the turbine engine 10.

The first controller 402a detects that the second turbine engine 10b is in the standby operating mode (e.g., based on the operating mode signals) and provides electrical power from the first turbine engine 10a (e.g., the first electric machine 70a) to the second turbine engine 10b (e.g., the second electric machine 70b) such that the first turbine engine 10a powers the second turbine engine 10b. During the standby operating mode of the second turbine engine 10b, the first controller 402a controls the second turbine engine 10b and the second propulsor 38b based on the input from the first single throttle lever 404a. In this way, the first controller 402a controls the rotational speed of the first turbo-engine 16a and the second turbo-engine 16b, the rotational speed and the torque of the first propulsor 38a and the second propulsor 38b, and the pitch of the first propulsor blades 40a and the second propulsor blades 40b, based on the input from the first single throttle lever 404a. In some embodiments, the first controller 402a controls the second turbine engine 10b based on a predetermined position or a positional threshold of the first single throttle lever 404a. For example, the pilot could move the first single throttle lever 404a into the predetermined position or beyond the positional threshold during any operating mode to control the second turbine engine 10b with the first controller 402a, based on the position of the first single throttle lever 404a.

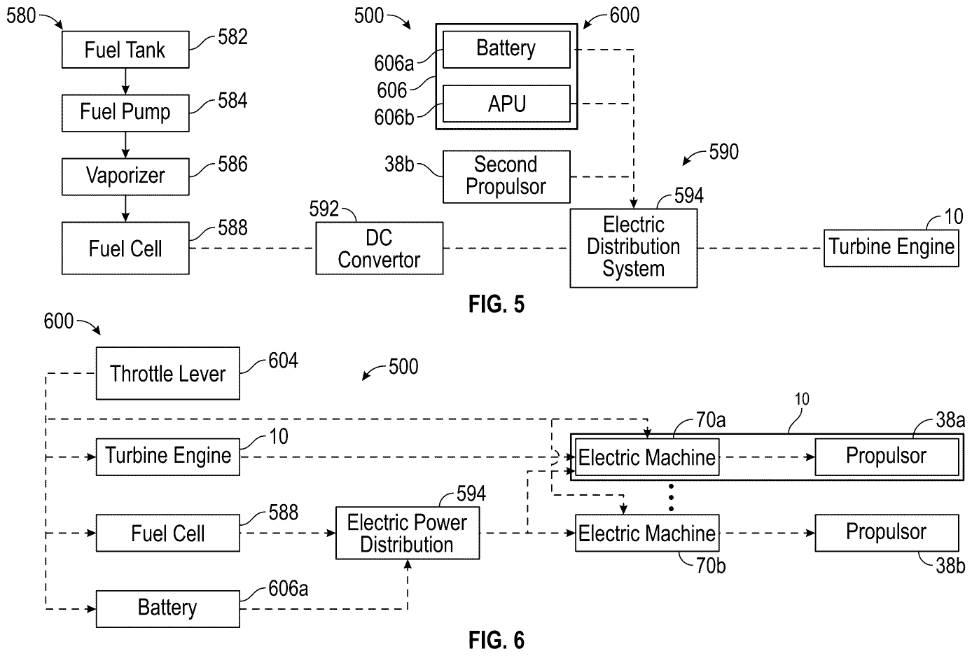

FIG. 5 is a schematic view of a propulsion system 500 having a turbine engine control system 600, according to another embodiment. FIG. 6 is a detailed, schematic view of the turbine engine control system 600, according to the present disclosure. The propulsion system 500 and the turbine engine control system 600 are substantially similar to the propulsion system 100 and the turbine engine control system 200 shown in FIGS. 2 and 3. The same or similar reference numerals will be used for components of the propulsion system 500 and the turbine engine control system 600 that are the same as or similar to the components of the propulsion system 100 and the turbine engine control system 200 discussed above, unless stated otherwise. The description of these components above also applies to this embodiment, and a detailed description of these components is omitted here.

The propulsion system 500 includes the turbine engine 10 having the first propulsor 38a and the first electric machine 70a (FIG. 6), the second propulsor 38b, and the second electric machine 70b (FIG. 6). The propulsion system 500 also includes a fuel system 580 for supplying fuel to the turbine engine 10 and for generating electricity with a fuel cell for electric components of the turbine engine 10 or of the aircraft. The fuel system 580 includes a fuel tank 582 for storing the fuel therein, a fuel pump 584, a vaporizer 586, and a fuel cell 588. The fuel tank 582 can be located on an aircraft (not shown) to which the turbine engine 10 is attached. While a single fuel tank 582 is shown in FIG. 5, the fuel system 580 can include any number of fuel tanks 582, as desired. The fuel system 580 includes one or more lines, conduits, pipes, tubes, etc., configured to carry the fuel from the fuel tank 582 to the fuel cell 588. The fuel pump 584 induces the flow of the fuel through the fuel system 580 to the fuel cell 588. In this way, the fuel pump 584 pumps the fuel from the fuel tank 582, through the fuel system 580, and into the fuel cell 588. In some embodiments, the fuel system 580 supplies the fuel to the combustor 26 (FIG. 1) to be combusted for generating thrust for the turbine engine 10.

In FIGS. 5 and 6, the fuel is a hydrogen fuel that is stored in the fuel tank 582 as liquid hydrogen fuel. The vaporizer 586 heats the liquid hydrogen fuel flowing through the fuel system 580. The vaporizer 586 is positioned in the flow path of the fuel between the fuel tank 582 and the fuel cell 588, and is located downstream of the fuel pump 584. While one vaporizer 586 is shown in FIG. 5, the fuel system 580 can include any number of vaporizers 586, as desired. The vaporizer 586 is in thermal communication with at least one heat source, such as, for example, waste heat from the turbine engine 10 or from one or more aircraft systems of the aircraft. The vaporizer 586 heats the liquid hydrogen fuel and the liquid hydrogen fuel is converted into a gaseous hydrogen fuel within the vaporizer 586. The fuel system 580 directs the gaseous hydrogen fuel into the fuel cell 588. The fuel cell 588 includes a fuel cell that converts chemical energy of the fuel (e.g., the gaseous hydrogen fuel) and an oxidizing agent (e.g., oxygen) into electricity through a pair of redox reactions. In this way, the fuel cell 588 receives the gaseous hydrogen fuel and the oxidizing agent, and generates electricity. The fuel cell 588 outputs the electricity to an electrical system 590. In some embodiments, the fuel system 580 supplies the gaseous hydrogen fuel for providing auxiliary power for the turbine engine 10. In some embodiments, the fuel system 580 supplies the gaseous hydrogen fuel to the combustor 26 (FIG. 1) for combusting the gaseous hydrogen fuel and generating thrust for the turbine engine 10.

The electrical system 590 includes a direct current (DC) converter 592 and an electric distribution system 594. The electrical system 590 supplies the electricity from the fuel cell 588 to the turbine engine 10 for powering one or more components of the turbine engine 10. The electrical system 590 can also supply the electricity to the one or more aircraft systems for powering the one or more aircraft systems. The one or more aircraft systems can include, for example, an electrical machine for the turbine engine 10 (e.g., for providing additional power to the gearbox assembly 46 such that the turbine engine 10 is a hybrid-electric engine), avionic systems, electric pumps (e.g., for controlling flaps), air conditioning, internal lights, external lights, passenger accessories (e.g., video screens, LCD screens, power hookups, or USB hookups, etc., or combinations thereof), the first electric machine 70a, the second electric machine 70b, or to other electrical systems of the aircraft, the turbine engine 10, or combinations thereof.

The DC converter 592 is a DC/DC converter that is an electronic circuit or an electromechanical device that converts a source of direct current from one voltage level to another voltage level. The DC converter 592 receives the electricity from the fuel cell 588 at a first voltage level and converts the electricity to a second voltage level. The electric distribution system 594 receives the electricity at the second voltage level and distributes the electricity to various systems of the turbine engine 10 (e.g., the first electric machine 70a), the second electric machine 70b, or of the aircraft.

The turbine engine control system 600 includes a single throttle lever 604 and an aircraft power supply 606 that also supplies electricity to the electric distribution system 594. The aircraft power supply 606 includes at least one of a battery 606a or an auxiliary power unit (APU) 606b of the aircraft. In this way, the electric distribution system 594 receives electricity from the fuel cell 588 and the aircraft power supply 606, and supplies the electricity to the turbine engine 10 or to the second electric machine 70b.

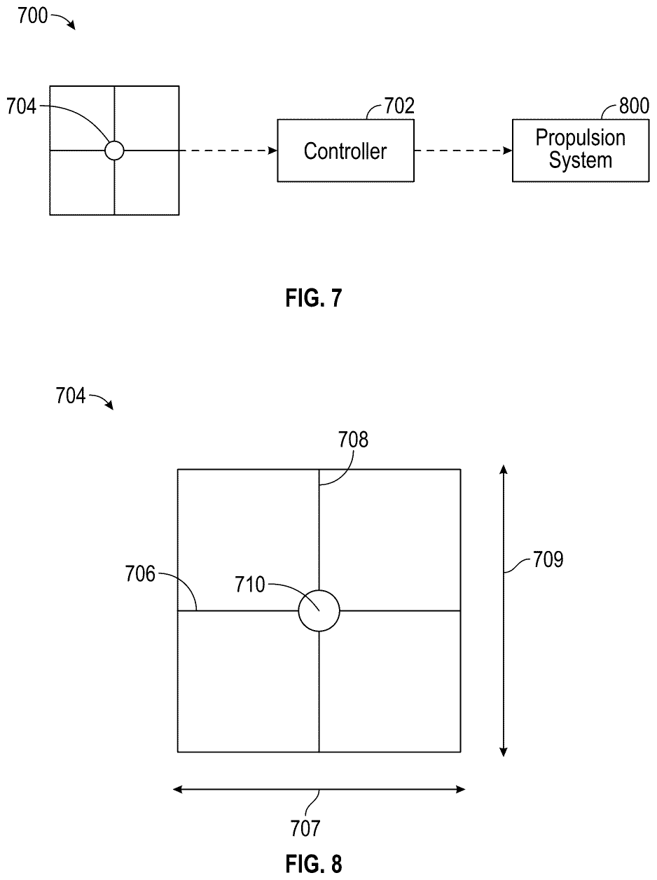

FIG. 7 is a schematic diagram of a turbine engine control system 700 for a propulsion system 800, according to the present disclosure. FIG. 8 is a schematic diagram of a single throttle lever 704 of the turbine engine control system 700, according to the present disclosure. The propulsion system 800 can embody any of the propulsion systems disclosed herein. The turbine engine control system 700 is substantially similar to the turbine engine control system 200 shown in FIGS. 2 and 3. The same or similar reference numerals will be used for components of the turbine engine control system 700 that are the same as or similar to the components of the turbine engine control system 200 discussed above, unless stated otherwise. The description of these components above also applies to this embodiment, and a detailed description of these components is omitted here.

The turbine engine control system 700 includes a controller 702 and the single throttle lever 704. The single throttle lever 704 can be a joystick, or the like. The single throttle lever 704 has a plurality of degrees of freedom for controlling a plurality of control functions of the propulsion system 800, as detailed further below.

With reference to FIG. 8, the single throttle lever 704 includes at least two degrees of freedom, including a first degree of freedom 706 and a second degree of freedom 708. In this way, the single throttle lever 704 can be translated in the first degree of freedom 706 as indicated by arrow 707. The single throttle lever 704 can also be translated in the second degree of freedom 708 as indicated by arrow 709. In particular, the single throttle lever 704 is configured for movement along an x-axis and a y-axis in a two-dimensional Cartesian coordinate system, such that the y-axis is orthogonal to the x-axis. In FIG. 8, the first degree of freedom 706 corresponds to the x-axis and the second degree of freedom 708 corresponds to the y-axis. The x-axis is defined by the single throttle lever 704 moving in a left direction or a right direction (as shown by the arrow 707) and the y-axis is defined by the single throttle lever 704 moving in a forward direction or an aft direction with respect to a user gripping the single throttle lever 704, for example, sitting in a cockpit of the aircraft. The single throttle lever 704 also includes a neutral position that is defined at coordinates (0,0) of the x-axis and the y-axis. The single throttle lever 704 can further be movable in and around any quadrant formed by the x-axis and the y-axis of the two-dimensional Cartesian coordinate system for controlling different control functions of the propulsion system 800 at any one time.

The single throttle lever 704 can also include a third degree of freedom 710 such that the single throttle lever 704 includes three degrees of freedom. In this way, the single throttle lever 704 can also be translated in the third degree of freedom 710. In particular, the single throttle lever 704 is configured for movement along a z-axis in a three-dimensional Cartesian coordinate system such that the z-axis is orthogonal to the x-axis and the y-axis in a third dimension. In FIG. 8, the third degree of freedom 710 corresponds to the z-axis. The z-axis is defined by the single throttle lever 704 moving in an inward direction or an outward direction (into the page or out of the page in the view of FIG. 8) with respect to the user gripping the single throttle lever 704, for example, sitting in the cockpit of the aircraft. In the three-dimensional Cartesian coordinate system, the neutral position is defined at coordinates (0,0,0) of the x-axis, the y-axis, and the z-axis.

The single throttle lever 704 can be spring-loaded such that the single throttle lever 704 automatically returns to the neutral position when the user releases the single throttle lever 704. In some embodiments, the single throttle lever 704 can remain stationary at a set position absent an input force from the user. The single throttle lever 704 can have a continuous motion such that the single throttle lever 704 can be positioned at any position along the first degree of freedom 706, the second degree of freedom 708, or the third degree of freedom 710. In some embodiments, the single throttle lever 704 can have a discrete number of fixed positions (e.g., by a predetermined number of detents) such that the single throttle lever 704 can be positioned at the discrete number of fixed positions in the first degree of freedom 706, the second degree of freedom 708, or the third degree of freedom 710.

With reference back to FIG. 7, the controller 702 is in communication with the single throttle lever 704. The controller 702 receives signals indicative of the position of the single throttle lever 704 in each of the two or more degrees of freedom. In particular, the controller 702 receives a first position input in the first degree of freedom 706 and a second position input in the second degree of freedom 708. The controller 702 can also receive a third position input in the third degree of freedom 706. The first position input, the second position input, and the third position input can be generated by any appropriate throttle lever sensing mechanism, such as, for example, a Hall effect sensor mechanism, or the like.

The first position input can correspond to a first position, also referred to as an x-axis position, of the single throttle lever 704 along the first degree of freedom 706. The x-axis position can include a left position, a right position, or the neutral position (e.g., x=0). From the neutral position, the single throttle lever 704 can be moved left or right along the first degree of freedom 706 (e.g., the x-axis) and the first position input includes a first current position of the single throttle lever 704 in the first degree of freedom 706.

The second position input can correspond to a second position, also referred to as a y-axis position, of the single throttle lever 704 along the second degree of freedom 708. The y-axis position can include a forward position, an aft position, or the neutral position (e.g., y=0). From the neutral position, the single throttle lever 704 can be moved forward or aft along the second degree of freedom 706 (e.g., the y-axis) and the second position input includes a second current position of the single throttle lever 704 in the second degree of freedom 706.

The third position input can correspond to a third position, also referred to as a z-axis position, of the single throttle lever 704 along the third degree of freedom 710. The z-axis position can include an inward position, an outward position, or the neutral position (e.g., z=0). From the neutral position, the single throttle lever 704 can be moved inward or outward along the third degree of freedom 710 (e.g., the z-axis) and the third position input includes a third current position of the single throttle lever 704 in the third degree of freedom 706.

The controller 702 receives the first position input, the second position input, and the third position input, and controls the propulsion system 800 based on the first position input, the second position input, and the third position input, as detailed further below. In particular, each of the first position input, the second position input, and the third position input corresponds to different control functions of the propulsion system. such as, for example at least one of a turbine engine setting, a first propulsor setting, or a second propulsor setting.

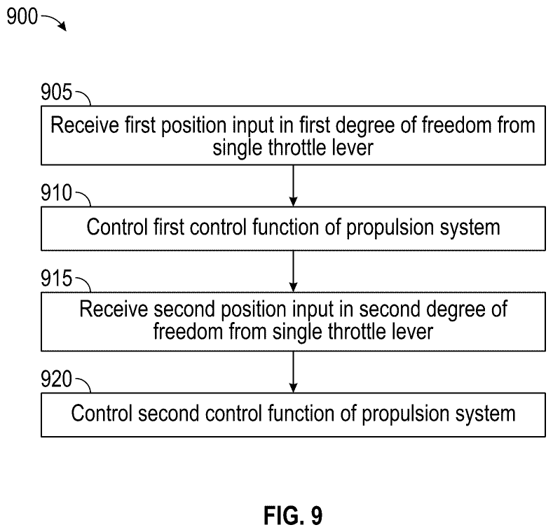

FIG. 9 is a flowchart of a method 900 of controlling a propulsion system 800, according to the present disclosure. While reference is made to the propulsion system 800, the method 900 can be utilized for any of the propulsion systems detailed herein. The method 900 can be performed by the controller 702 and reference is made to FIGS. 7 and 8. For purposes of the turbine engine control system 700, the propulsion system 800, and the method 900, a first propulsor can include at least one of the turbine engine 10 or the first propulsor 38a shown in FIGS. 2 and 3, and a second propulsor can include the second propulsor 38b of FIGS. 2 and 3. In some embodiments, the first propulsor can include at least one of the first turbine engine 10a or the first propulsor 38a shown in FIG. 4, and the second propulsor can include at least one of the second turbine engine 10b or the second propulsor 38b shown in FIG. 4.

In step 905, the method 900 includes receiving the first position input in the first degree of freedom 706 from the single throttle lever 704. In particular, the controller 702 receives the first position input from the single throttle lever 704. The first position input includes a current position of the single throttle lever 704 in the first degree of freedom 706. For example, the first position input includes the current position of the single throttle lever 704 along the x-axis. The first position input includes the single throttle lever 704 moving along a first direction in the first degree of freedom 706 or moving along a second direction in the first degree of freedom 706 with respect to the neutral position. For example, the first direction can be leftward from the neutral position and the second direction can be rightward from the neutral position.

In step 910, the method 900 includes controlling a first control function of the propulsion system 800. In particular, the controller 702 converts the first position input into a first control function setting based on the position of the single throttle lever 704 in the first degree of freedom 706. The first control function setting includes at least one of a turbine engine setting, a first propulsor setting, or a second propulsor setting, similar to the turbine engine control system 200 shown in FIGS. 2 and 3. Examples of the first control function are provided below in Embodiment 1 and Embodiment 2.

In step 915, the method 900 includes receiving the second position input in the second degree of freedom 708 from the single throttle lever 704. In particular, the controller 702 receives the second position input from the single throttle lever 704. The second position input includes a current position of the single throttle lever 704 in the second degree of freedom 708. For example, the second position input includes the current position of the single throttle lever 704 along the y-axis. The second position input includes the single throttle lever 704 moving along a first direction in the second degree of freedom 708 or moving along a second direction in the second degree of freedom 708 with respect to the neutral position. For example, the first direction can be forward from the neutral position and the second direction can be aft (e.g., rearward) from the neutral position.

In step 920, the method 900 includes controlling a second control function of the propulsion system 800. In particular, the controller 702 converts the second position input into a second control function setting based on the position of the single throttle lever 704 in the second degree of freedom 708. The second control function setting includes at least one of a turbine engine setting, a first propulsor setting, or a second propulsor setting, similar to the turbine engine control system 200 shown in FIGS. 2 and 3. Examples of the second control function are provided below in Embodiment 1 and Embodiment 2.

In some embodiments, the method 900 includes receiving the third position input in the third degree of freedom 710 from the single throttle lever 704. In particular, the controller 702 receives the third position input from the single throttle lever 704. The third position input includes a current position of the single throttle lever 704 in the third degree of freedom 710. For example, the third position input includes the current position of the single throttle lever 704 along the z-axis. The third position input includes the single throttle lever 704 moving along a first direction in the third degree of freedom 710 or moving along a second direction in the third degree of freedom 710 with respect to the neutral position. For example, the first direction can be inward from the neutral position and the second direction can be aft outward from the neutral position. In this embodiment, the method 900 includes controlling a third control function of the propulsion system 800. In particular, the controller 702 converts the third position input into a third control function setting based on the position of the single throttle lever 704 in the third degree of freedom 710. The third control function setting includes at least one of a turbine engine setting, a first propulsor setting, or a second propulsor setting, similar to the turbine engine control system 200 shown in FIGS. 2 and 3. Examples of the third control function are provided below in Embodiment 1 and Embodiment 2.

The directions in the first degree of freedom 706, the second degree of freedom 708, and the third degree of freedom 710 are exemplary, and the directions can be selected for a particular application of the single throttle lever 704. For example, the first degree of freedom 706, the second degree of freedom 708, and the third degree of freedom 710, respectively, can be along any of the x-axis, the y-axis, or the z-axis. For example, the first degree of freedom 706 can be along the y-axis, the second degree of freedom 708 can be along the x-axis, and the third degree of freedom 710 can be along the z-axis.

Embodiment 1 and Embodiment 2 provided below are non-limiting exemplary embodiments of the first control function, the second control function, and the third control function disclosed herein. The first control function, the second function, and the third control function, respectively, can be assigned to any of the first degree of freedom 706, the second degree of freedom 708, or the third degree of freedom 710. Further, control functions of the propulsion system 800 other than those explicitly disclosed herein are also contemplated as part of the present disclosure.

### Embodiment 1

In Embodiment 1, the first control function is a thrust level split between a first propulsor (e.g., the first turbine engine 10a or the first propulsor 38a) and a second propulsor (e.g., the second turbine engine 10b or the second propulsor 38b). For example, positions of the single throttle lever 704 more to the first direction (e.g., leftward) in the first degree of freedom 706 can bias a greater thrust level from the first propulsor and a lesser thrust level from the second propulsor. Positions of the single throttle lever 704 more to the second direction (e.g., rightward) in the first degree of freedom 706 can bias a greater thrust level from the second propulsor and a lesser thrust level from the first propulsor. The neutral position (e.g., x=0) in the first degree of freedom 706 corresponds to a substantially equal thrust level from the first propulsor and the second propulsor.

For example, if the single throttle lever 704 is moved left to 80% of a total amount the single throttle lever 704 can be moved to the left, the thrust level from the first propulsor is 80% of the total thrust level from the first propulsor and the second propulsor, and the thrust level from the second propulsor is 20% of the total thrust level. Similarly, if the single throttle lever 704 is moved to the right to 80% of a total amount the single throttle lever 704 can be moved to the right, the thrust level from the second propulsor is 80% of the total thrust level, and the thrust level from the first propulsor is 20% of the total thrust level.

In Embodiment 1, the second control function is a thrust level of the first propulsor and the second propulsor. For example, positions of the single throttle lever 704 more to the first direction (e.g., forward) in the second degree of freedom 708 correspond to a greater thrust level of the first propulsor and the second propulsor. Positions of the single throttle lever 704 more to the second direction (e.g., aft or rearward) in the second degree of freedom 708 correspond to a lesser thrust level of the first propulsor and the second propulsor. Once the thrust level is selected by moving the single throttle lever 704, the single throttle lever 704 can be moved to the neutral position (e.g., y=0) in the second degree of freedom 708 without changing the thrust level. For example, the user can hold the single throttle lever 704 at the current position for a predetermined amount of time (e.g., three seconds) or actuate a button or a switch when the single throttle lever 704 is at a desired position to select the thrust level and then allow the single throttle lever 704 to move back to the neutral position without the thrust level changing.

In this example, the thrust level of the first propulsor and the second propulsor increases as the single throttle lever 704 is moved in the first direction (e.g., forward) in the second degree of freedom 708 (e.g., towards a high-power operation). The thrust level of the first propulsor and the second propulsor decreases as the single throttle lever 704 is moved in the second direction (e.g., aft) in the second degree of freedom 708 (e.g., towards a low-power operation).

In Embodiment 1, the third control function is a switch between forward thrust and reverse thrust of the first propulsor and the second propulsor. For example, a position of the single throttle lever 704 in the first direction (e.g., inward) in the third degree of freedom 710 selects forward thrust (e.g., in a direction of travel of the aircraft) of the first propulsor and the second propulsor. When forward thrust is selected, moving the single throttle lever 704 in the second degree of freedom 708 controls a forward thrust level. A position of the single throttle lever 704 in the second direction (e.g., outward) in the third degree of freedom 710 selects reverse thrust (e.g., in a direction opposite the direction of travel of the aircraft) of the first propulsor and the second propulsor. When reverse thrust is selected, moving the single throttle lever 704 in the second degree of freedom 708 controls a reverse thrust level.

### Embodiment 2

In Embodiment 2, the first propulsor includes the turbine engine 10 having the first electric machine 70a, and the first control function is a power level split between the turbo-engine 16 and the first electric machine 70a of the turbine engine 10. For example, positions of the single throttle lever 704 more to the first direction (e.g., leftward) in the first degree of freedom 706 can bias a greater power level from the turbo-engine 16 and a less thrust level from the first electric machine 70a. Positions of the single throttle lever 704 more to the second direction (e.g., rightward) in the first degree of freedom 706 can bias a greater power level from the first electric machine 70a and a lesser power level from the turbo-engine 16. The neutral position (e.g., x=0) in the first degree of freedom 706 corresponds to a substantially equal power level from the turbo-engine 16 and the first electric machine 70a.

For example, if the single throttle lever 704 is moved to 80% of a total amount the single throttle lever 704 can be moved to the left, the power level from the turbo-engine 16 is 80% of the total power level from the turbo-engine 16 and the first electric machine 70a, and the power level from the first electric machine 70a is 20% of the total power level. Similarly, if the single throttle lever 704 is moved to the right to 80% of a total amount of the single throttle lever 704 can be moved to the right, the power level from the first electric machine 70a is 80% of the total power level, and the power level from the turbo-engine 16 is 20% of the total power level. When the single throttle lever 704 is 100% left in the first degree of freedom 706, the power level from the turbo-engine 16 is 100% and the first electric machine 70a is turned off (e.g., the power level of the first electric machine 70a is zero) such that the turbine engine 10 receives zero power from the first electric machine 70a (e.g., 100% power from the turbo-engine 16 and 0% power from the first electric machine 70a). In this way, the turbo-engine 16 operates as detailed above to power the turbine engine 10 and to provide thrust for the turbine engine 10. When the single throttle lever 704 is 100% right in the first degree of freedom 706, the power level of the first electric machine 70a is 100% and the turbo-engine 16 is turned off (e.g., the power level of the turbo-engine 16 is zero) such that the turbine engine 10 receives zero power from the turbo-engine 16 (e.g., 100% from the first electric machine 70a and 0% power from the turbo-engine 16). In this way, the first electric machine 70a operates as detailed above to power to the turbine engine 10 and to provide thrust for the turbine engine 10. When the single throttle lever 704 is at the neutral position (e.g., x=0) in the first degree of freedom 706, there is a balance of power from the turbo-engine 16 and the first electric machine 70a (e.g., 50% power from the turbo-engine 16 and 50% power from the first electric machine 70a). The single throttle lever 704 can move in the first degree of freedom 706 to any position between the 100% in left, 100% right, or the neutral position to control a power level between the turbo-engine 16 and the first electric machine 70a to any value between 0% and 100%.

In Embodiment 2, the second control function is a thrust direction level of the first propulsor and the second propulsor. For example, positions of the single throttle lever 704 that are more toward the first direction (e.g., forward) in the second degree of freedom 708 correspond to a forward thrust level (e.g., forward in the direction of travel of the aircraft) of the first propulsor and the second propulsor. Positions of the single throttle lever 704 that are more toward the second direction (e.g., aft) in the second degree of freedom 708 correspond to a reverse thrust level (e.g., opposite the direction of travel of the aircraft) of the first propulsor and the second propulsor. The neutral position (e.g., y=0) in the second degree of freedom 708 corresponds to zero thrust, otherwise known as idle.

In this example, the forward thrust level increases (e.g., from idle towards the high-power operation) as the single throttle lever 704 moves in the first direction (e.g., forward) away from the neutral position and decreases as the single throttle lever 704 moves in the first direction back towards the neutral position. In this way, the forward thrust level is proportional to the position of the single throttle lever 704 in the first direction along the second degree of freedom 708. For example, positions in the first direction of the single throttle lever 704 from 0% to 30% of a total extent of the single throttle lever 704 in the first direction correspond to the low-power operation, from 30% to 85% correspond to the mid-power operation, and from 85% to 100% correspond to the high-power operation. Similarly, the reverse thrust level increases as the single throttle lever 704 moves in the second direction (e.g., aft) away from the neutral position and decreases as the single throttle lever 704 moves in the second direction back towards to the neutral position.

In Embodiment 2, the third control function is a selection to control one of the first propulsor or the second propulsor, or both the first propulsor and the second propulsor. For example, a position of the single throttle lever 704 in the first direction (e.g., inward) in the third degree of freedom 710 selects only the first propulsor to control (and excludes control of the second propulsor). When only the first propulsor is selected, moving the single throttle lever 704 in the first degree of freedom 706 controls the first control function of only the first propulsor (e.g., the power source selection of the first propulsor). Moving the single throttle lever 704 in the second degree of freedom 708 controls the second control function of only the first propulsor (e.g., the forward thrust level or the reverse thrust level of the first propulsor). A position of the single throttle lever 704 in the second direction (e.g., outward) in the third degree of freedom 710 selects only the second propulsor to control (and excludes control of the first propulsor).

When only the second propulsor is selected, moving the single throttle lever 704 in the first degree of freedom 706 controls the first control function of only the second propulsor (e.g., the power source selection of the second propulsor). Moving the single throttle lever 704 in the second degree of freedom 708 controls the second control function of only the second propulsor (e.g., the forward thrust level or reverse thrust level of the second propulsor).

When the single throttle lever 704 is at the neutral position (e.g., z=0) in the third degree of freedom 710, the controller 702 controls both the first propulsor and the second propulsor together. For example, moving the single throttle lever 704 in the first degree of freedom 706 controls the first control function of both the first propulsor and the second propulsor (e.g., the power source selection of the first propulsor and the second propulsor). Moving the single throttle lever 704 in the second degree of freedom 708 controls the second control function of both the first propulsor and the second propulsor (e.g., the forward thrust level or the reverse thrust level of the first propulsor and the second propulsor).

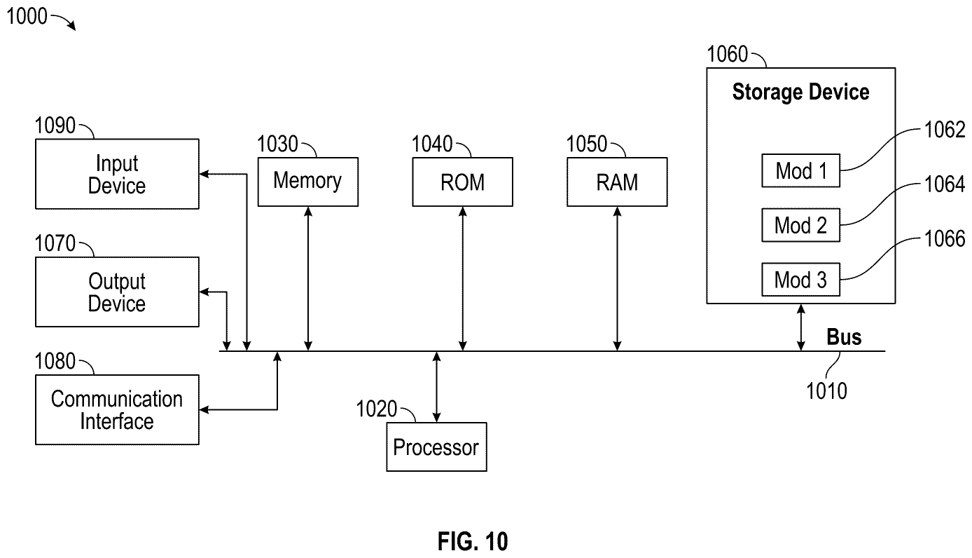

FIG. 10 shows a computing system 1000, according to the present disclosure. The computing system 1000 may carry out any of the methods or systems described herein. The controllers described previously herein may be operated according to the computing system 1000. The computing system 1000 includes a general-purpose computing device, including a central processing unit (CPU), or a processor 1020, and a system bus 1010 that couples various system components, including a system memory 1030 such as a read-only memory (ROM) 1040 and a random-access memory (RAM) 1050, to the processor 1020. The computing system 1000 can include a cache of high-speed memory connected directly with, in close proximity to, or integrated as part of the processor 1020. The computing system 1000 copies data from the system memory 1030 or the storage device 1060 to the cache for quick access by the processor 1020. In this way, the cache provides a performance boost that avoids the processor 1020 delays while waiting for data. These and other modules can control or be configured to control the processor 1020 to perform various actions. Other system memory 1030 may be available for use as well. The system memory 1030 can include multiple different types of memory with different performance characteristics. The disclosure may operate on a computing system 1000 with more than one processor 1020 or on a group or a cluster of computing devices networked together to provide greater processing capability. The processor 1020 can include any general-purpose processor and a hardware module or a software module, such as module 1 1062, module 2 1064, and module 3 1066 stored in the storage device 1060, configured to control the processor 1020, as well as a special-purpose processor where software instructions are incorporated into the actual processor design. The processor 1020 may essentially be a completely self-contained computing system, containing multiple cores or processors, a bus, memory controller, cache, etc. A multi-core processor may be symmetric or asymmetric.

The system bus 1010 may be any of several types of bus structures, including a memory bus or a memory controller, a peripheral bus, and a local bus using any of a variety of bus architectures. A basic input/output system (BIOS) stored in the ROM 1040, or the like, may provide the basic routine that helps to transfer information between elements within the computing system 1000, such as during start-up. The computing system 1000 further includes one or more storage devices 1060 such as a hard disk drive, a magnetic disk drive, an optical disk drive, a tape drive, or the like. The storage devices 1060 can include software modules 1062, 1064, and 1066 for controlling the processor 1020. Other hardware or software modules are contemplated. The storage device 1060 is connected to the system bus 1010 by a drive interface. The drives and the associated computer-readable storage media provide nonvolatile storage of computer-readable instructions, data structures, program modules, and other data for the computing system 1000. In one aspect, a hardware module that performs a particular function includes the software component stored in a tangible computer-readable storage medium in connection with the necessary hardware components, such as the processor 1020, the system bus 1010, the output device 1070, and so forth, to carry out the function. In another aspect, the computing system 1000 can use a processor and a computer-readable storage medium to store instructions that, when executed by a processor (e.g., one or more processors), cause the processor to perform a method or other specific actions. The basic components and appropriate variations are contemplated depending on the type of device, such as whether the computing system 1000 is a small, handheld computing device, a desktop computer, or a computer server.

Although the exemplary embodiment described herein employs the storage device 1060, other types of computer-readable media that can store data that are accessible by a computer, such as magnetic cassettes, flash memory cards, digital versatile disks, cartridges, random-access memories (RAMs) 1050, and a read-only memory (ROM) 1040, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing system 1000, an input device 1090 represents any number of input mechanisms, such as a microphone for speech, a touch-sensitive screen for a gesture, or graphical input, a keyboard, a mouse, motion input, speech, and so forth. An output device 1070 can also be one or more of a number of output mechanisms known to those of skill in the art. In some instances, multimodal systems enable a user to provide multiple types of input to communicate with the computing system 1000. The communications interface 1080 generally governs and manages the user input and system output. There is no restriction on operating on any particular hardware arrangement and, therefore, the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Accordingly, the present disclosure provides for propulsion systems that include hybrid electric turboprop engines. The turbine engine control systems herein can control the turbine engine and the remote propulsor based on a single throttle lever input. In this way, the propulsion systems of the present disclosure require only a single throttle lever to be actuated by the pilot to control both the turbine engine and the remote propulsor, thus, reducing pilot workload, allowing the pilot to better focus attention on other needs. Further, the single throttle lever having two or more degrees of freedom provides for controlling multiple functions of the propulsion system with a single device, and, thus, reduces the overall complexity of the system and reduces pilot workload as compared to turbine engine control systems without the benefit of the present disclosure.

Further aspects of the present disclosure are provided by the subject matter of the following clauses.

A turbine engine control system for a propulsion system including a turbine engine having a turbo-engine and a first propulsor drivingly coupled to the turbo-engine, and a second propulsor that is remote from the turbine engine, the turbine engine control system comprising a single throttle lever, and a controller that receives an input from the single throttle lever, and controls the turbine engine and the second propulsor based on the input from the single throttle lever.

The turbine engine control system of the preceding clause, wherein the controller controls at least one of a rotational speed of the turbo-engine, a rotational speed of the first propulsor, a pitch of a plurality of first propulsor blades of the first propulsor, or a torque of the first propulsor.

The turbine engine control system of any preceding clause, wherein the controller controls at least one of a rotational speed of the second propulsor, a pitch of a plurality of second propulsor blades of the second propulsor, or a torque of the second propulsor.

The turbine engine control system of any preceding clause, wherein the controller receives a position input from the single throttle lever, converts the position input into at least one of a turbo-engine setting, a first propulsor setting, or a second propulsor setting, and controls the second propulsor and at least one of the turbo-engine or the first propulsor based on the at least one of the turbo-engine setting, the first propulsor setting, or the second propulsor setting.

The turbine engine control system of any preceding clause, further comprising an aircraft power supply that powers the second propulsor.

The turbine engine control system of any preceding clause, wherein the turbine engine is a first turbine engine and the turbo-engine is a first turbo-engine, the propulsion system further including a second turbine engine having a second turbo-engine, and the second propulsor being drivingly coupled to the second turbo-engine.

The turbine engine control system of the preceding clause, wherein the controller controls the second turbine engine based on the input from the single throttle lever when the second turbine engine is in a standby operating mode or a failure mode.

The turbine engine control system of any preceding clause, wherein the propulsion system includes a first electric machine that is drivingly coupled to the first propulsor, the first electric machine powering the first propulsor when the turbine engine is shut down.

The turbine engine control system of the preceding clause, wherein the propulsion system includes a second electric machine that is drivingly coupled to the second propulsor, the second electric machine powering the second propulsor.

The turbine engine control system of the preceding clause, further comprising a power conduit that provides electrical communication from the first electric machine to the second electric machine, the first electric machine powering the second electric machine through the power conduit.

A method of operating the propulsion system of any preceding clause, the method comprising operating the turbine engine of the propulsion system, operating the second propulsor, and controlling the turbine engine and the second propulsor based on the input from the single throttle lever.

The method of the preceding clause, further comprising controlling at least one of a rotational speed of the turbo-engine, a rotational speed of the first propulsor, a pitch of a plurality of first propulsor blades of the first propulsor, or a torque of the first propulsor.

The method of any preceding clause, further comprising controlling at least one of a rotational speed of the second propulsor, a pitch of a plurality of second propulsor blades of the second propulsor, or a torque of the second propulsor.

The method of any preceding clause, further comprising receiving a position input from the single throttle lever, converting the position input into at least one of a turbo-engine setting, a first propulsor setting, or a second propulsor setting, and controlling the second propulsor and at least one of the turbo-engine or the first propulsor based on the at least one of the turbo-engine setting, the first propulsor setting, or the second propulsor setting.

The method of any preceding clause, wherein the propulsion system includes an aircraft power supply, the method further comprising powering the second propulsor with the aircraft power supply.

The method of any preceding clause, wherein the turbine engine is a first turbine engine and the turbo-engine is a first turbo-engine, the method further comprising driving the second propulsor with a second turbo-engine of a second turbine engine.

The method of the preceding clause, further comprising controlling the second turbine engine based on the input from the single throttle lever when the second turbine engine is in a standby operating mode or a failure mode.

The method of any preceding clause, further comprising powering the first propulsor with a first electric machine when the turbine engine is shut down.

The method of the preceding clause, further comprising powering the second propulsor with a second electric machine.

The method of the preceding clause, further comprising powering the second electric machine with the first electric machine through a power conduit.

A turbine engine control system for a propulsion system, including a first propulsor and a second propulsor that is separate from the first propulsor, comprises a single throttle lever having at least two degrees of freedom, including a first degree of freedom and a second degree of freedom, and a controller that receives a first position input from the single throttle lever in the first degree of freedom, controls a first control function of at least one of the first propulsor or the second propulsor of the propulsion system based on the first position input from the single throttle lever, receives a second position input from the single throttle lever in the second degree of freedom, and controls a second control function of at least one of the first propulsor or the second propulsor of the propulsion system based on the second position input from the single throttle lever.

The turbine engine control system of the preceding clause, the first control function being a thrust level split between the first propulsor and the second propulsor.

The turbine engine control system of any preceding clause, a first direction of the single throttle lever in the first degree of freedom corresponding to a greater thrust level from the first propulsor and a lesser thrust level from the second propulsor, and a second direction of the single throttle lever in the first degree of freedom corresponds to a greater thrust level from the second propulsor and a lesser thrust level from the first propulsor.

The turbine engine control system of any preceding clause, the first propulsor including a turbine engine having a turbo-engine and an electric machine, and the first control function is a power level between the turbo-engine and the electric machine for the turbine engine.

The turbine engine control system of any preceding clause, a first direction of the single throttle lever in the first degree of freedom corresponding to a greater power level from the turbo-engine and a lesser power level from the electric machine, and a second direction of the single throttle lever in the first degree of freedom corresponds to a greater power level from the electric machine and a lesser power level from the turbo-engine.

The turbine engine control system of any preceding clause, the second control function being a thrust level of the first propulsor and the second propulsor.

The turbine engine control system of any preceding clause, a first direction of the single throttle lever in the second degree of freedom corresponding to a greater thrust level of the first propulsor and the second propulsor, and a second direction of the single throttle lever in the second degree of freedom corresponds to a lesser thrust level of the first propulsor and the second propulsor.

The turbine engine control system of any preceding clause, a first direction of the single throttle lever in the second degree of freedom corresponding to a forward thrust level of the first propulsor and the second propulsor, and a second direction of the single throttle lever in the second degree of freedom corresponds to a reverse thrust level of the first propulsor and the second propulsor.

The turbine engine control system of any preceding clause, the single throttle lever having a third degree of freedom, and the controller receives a third position input from the single throttle lever in the third degree of freedom and controls a third control function of at least one of the first propulsor or the second propulsor.

The turbine engine control system of any preceding clause, the third control function being a switch between a forward thrust and a reverse thrust of the first propulsor and the second propulsor.

The turbine engine control system of any preceding clause, a first direction of the single throttle lever in the third degree of freedom selecting the forward thrust for the first propulsor and the second propulsor, and a second direction of the single throttle lever in the third degree of freedom selects the reverse thrust for the first propulsor and the second propulsor.

The turbine engine control system of any preceding clause, the third control function being a selection to control one of the first propulsor or the second propulsor, or both the first propulsor and the second propulsor.

The turbine engine control system of any preceding clause, a first direction of the single throttle lever in the third degree of freedom selecting only the first propulsor for control, a second direction of the single throttle lever in the third degree of freedom selects only the second propulsor for control, and a neutral position of the single throttle lever in the third degree of freedom selects both the first propulsor and the second propulsor for control.

A turbine engine control system for a propulsion system, including a first propulsor and a second propulsor that is separate from the first propulsor, comprises a single throttle lever having at least two degrees of freedom including a first degree of freedom and a second degree of freedom and a controller that receives a first position input from the single throttle lever in the first degree of freedom, controls a thrust level split of at least one of the first propulsor or the second propulsor of the propulsion system based on the first position input from the single throttle lever, receives a second position input from the single throttle lever in the second degree of freedom, and controls a thrust level of the first propulsor and the second propulsor based on the second position input from the single throttle lever.

The turbine engine control system of the preceding clause, a first direction of the single throttle lever in the first degree of freedom corresponding to a greater thrust level from the first propulsor and a lesser thrust level from the second propulsor, and a second direction of the single throttle lever in the first degree of freedom corresponds to a greater thrust level from the second propulsor and a lesser thrust level from the first propulsor, and a first direction of the single throttle lever in the second degree of freedom corresponding to a greater thrust level of the first propulsor and the second propulsor, and a second direction of the single throttle lever in the second degree of freedom corresponds to a lesser thrust level of the first propulsor and the second propulsor.

The turbine engine control system of any preceding clause, the single throttle lever having a third degree of freedom, and the controller receives a third position input from the single throttle lever in the third degree of freedom and controls a switch between a forward thrust and a reverse thrust of the first propulsor and the second propulsor.

The turbine engine control system of any preceding clause, a first direction of the single throttle lever in the third degree of freedom selecting the forward thrust for the first propulsor and the second propulsor, and a second direction of the single throttle lever in the third degree of freedom selects the reverse thrust for the first propulsor and the second propulsor.

A turbine engine control system for a propulsion system, including a first propulsor and a second propulsor that is separate from the first propulsor, the first propulsor being a turbine engine having a turbo-engine and an electric machine, and comprises a single throttle lever having at least two degrees of freedom, including a first degree of freedom and a second degree of freedom, and a controller that receives a first position input from the single throttle lever in the first degree of freedom, controls a power level between the turbo-engine and the electric machine for the turbine engine based on the first position input from the single throttle lever, receives a second position input from the single throttle lever in the second degree of freedom, and controls a thrust level of the first propulsor and the second propulsor based on the second position input from the single throttle lever.

The turbine engine control system of the preceding clause, a first direction of the single throttle lever in the first degree of freedom corresponding to a greater power level from the turbo-engine and a lesser power level from the electric machine, and a second direction of the single throttle lever in the first degree of freedom corresponds to a greater power level of the turbine engine from the electric machine and a lesser power level from the turbo-engine, and a first direction of the single throttle lever in the second degree of freedom corresponding to a forward thrust level of the first propulsor and the second propulsor, and a second direction of the single throttle lever in the second degree of freedom corresponds to a reverse thrust level of the first propulsor and the second propulsor.

The turbine engine control system of any preceding clause, the single throttle lever having a third degree of freedom, and the controller receives a third position input from the single throttle lever in the third degree of freedom and controls a selection to control one of the first propulsor or the second propulsor, or both the first propulsor and the second propulsor.

A method of operating a propulsion system, the method comprising receiving a first position input from a single throttle lever in a first degree of freedom of the single throttle lever, controlling a first control function of at least one of a first propulsor or a second propulsor of the propulsion system based on the first position input from the single throttle lever, receiving a second position input from a single throttle lever in a second degree of freedom of the single throttle lever, and controlling a second control function of at least one of the first propulsor or the second propulsor of the propulsion system based on the second position input from the single throttle lever.

The method of the preceding clause, wherein the first control function is a thrust level split between the first propulsor and the second propulsor.

The method of the preceding clause, wherein a first direction of the single throttle lever in the first degree of freedom corresponds to a greater thrust level from the first propulsor and a lesser thrust level from the second propulsor, and a second direction of the single throttle lever in the first degree of freedom corresponds to a greater thrust level from the second propulsor and a lesser thrust level from the first propulsor.

The method of any preceding clause, wherein the first propulsor includes a turbine engine having a turbo-engine and an electric machine, and the first control function is a power level between the turbo-engine and the electric machine for the turbine engine.

The method of the preceding clause, wherein a first direction of the single throttle lever in the first degree of freedom corresponds to a greater power level from the turbo-engine and a lesser power level from the electric machine, and a second direction of the single throttle lever in the first degree of freedom corresponds to a greater power level from the electric machine and a lesser power level from the turbo-engine.

The method of any preceding clause, wherein the second control function is a thrust level of the first propulsor and the second propulsor.

The method of the preceding clause, wherein a first direction of the single throttle lever in the second degree of freedom corresponds to a greater thrust level of the first propulsor and the second propulsor, and a second direction of the single throttle lever in the second degree of freedom corresponds to a lesser thrust level of the first propulsor and the second propulsor.

The method of any preceding clause, wherein a first direction of the single throttle lever in the second degree of freedom corresponds to a forward thrust level of the first propulsor and the second propulsor, and a second direction of the single throttle lever in the second degree of freedom corresponds to a reverse thrust level of the first propulsor and the second propulsor.

The method of any preceding clause, further comprising receiving a third position input from the single throttle lever in a third degree of freedom of the single throttle lever, and controlling a third control function of at least one of the first propulsor or the second propulsor based on the third position input from the single throttle lever.

The method of the preceding clause, wherein the third control function is a switch between a forward thrust and a reverse thrust of the first propulsor and the second propulsor.

The method of the preceding clause, wherein a first direction of the single throttle lever in the third degree of freedom selects the forward thrust for the first propulsor and the second propulsor, and a second direction of the single throttle lever in the third degree of freedom selects the reverse thrust for the first propulsor and the second propulsor.

The method of any preceding clause, wherein the third control function is a selection to control one of the first propulsor or the second propulsor, or both the first propulsor and the second propulsor.

The method of the preceding clause, wherein a first direction of the single throttle lever in the third degree of freedom selects only the first propulsor for control, a second direction of the single throttle lever in the third degree of freedom selects only the second propulsor for control, and a neutral position of the single throttle lever in the third degree of freedom selects both the first propulsor and the second propulsor for control.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbine engine control system for a propulsion system comprising a first turbine engine comprising a first turbo-engine and a first propulsor drivingly coupled to the first turbo-engine, and a second turbine engine comprising a second turbo-engine and a second propulsor drivingly coupled to the second turbo-engine, the second turbine engine being separate from the first turbine engine, the turbine engine control system comprising:
a single throttle lever having at least two degrees of freedom, including a first degree of freedom and a second degree of freedom;
a first controller operatively coupled to the first turbine engine, the first controller receiving position inputs from the single throttle lever and controlling the first propulsor and the second propulsor accordingly;
a second controller operatively coupled to the second turbine engine to control the second propulsor; and
a data communication bus coupling the first controller and the second controller to transmit a signal indicative of an operating mode of the second turbine engine to the first controller,
wherein the first controller further:
receives a first position input from the single throttle lever in the first degree of freedom;
receives a second position input from the single throttle lever in the second degree of freedom;
converts each of the first position input and the second position input from the single throttle lever into at least one of a turbo-engine setting, a first propulsor setting, or a second propulsor setting;
controls a first control function of the first propulsor and the second propulsor based on the first position input from the single throttle lever and at least one of the first propulsor setting of the second propulsor setting; and
controls a second control function of the first propulsor and the second propulsor based on the second position input from the single throttle lever and at least one of the turbo-engine setting the first propulsor setting, or the second propulsor setting.

2. The turbine engine control system of claim 1, wherein the first control function is a thrust level split between the first propulsor and the second propulsor.

3. The turbine engine control system of claim 2, wherein a first direction of the single throttle lever in the first degree of freedom corresponds to a greater thrust level from the first propulsor and a lesser thrust level from the second propulsor, and a second direction of the single throttle lever in the first degree of freedom corresponds to a greater thrust level from the second propulsor and a lesser thrust level from the first propulsor.

4. The turbine engine control system of claim 1, wherein the first turbine engine further comprises a first electric machine, and the first control function is a power level between the first turbo-engine and the first electric machine for the turbine engine.

5. (canceled)

6. The turbine engine control system of claim 1, wherein the second control function is a thrust level of the first propulsor and the second propulsor.

7. The turbine engine control system of claim 6, wherein a first direction of the single throttle lever in the second degree of freedom corresponds to a greater thrust level of the first propulsor and the second propulsor, and a second direction of the single throttle lever in the second degree of freedom corresponds to a lesser thrust level of the first propulsor and the second propulsor.

8. The turbine engine control system of claim 6, wherein a first direction of the single throttle lever in the second degree of freedom corresponds to a forward thrust level of the first propulsor and the second propulsor, and a second direction of the single throttle lever in the second degree of freedom corresponds to a reverse thrust level of the first propulsor and the second propulsor.

9. The turbine engine control system of claim 1, wherein the single throttle lever has a third degree of freedom, and the first controller receives a third position input from the single throttle lever in the third degree of freedom and controls a third control function of at least one of the first propulsor or the second propulsor.

10. The turbine engine control system of claim 9, wherein the third control function is a switch between a forward thrust and a reverse thrust of the first propulsor and the second propulsor.

11. The turbine engine control system of claim 10, wherein a first direction of the single throttle lever in the third degree of freedom selects the forward thrust for the first propulsor and the second propulsor, and a second direction of the single throttle lever in the third degree of freedom selects the reverse thrust for the first propulsor and the second propulsor.

12. (canceled)

13. The turbine engine control system of claim 9, wherein the third control function is a selection to control one of the first propulsor or the second propulsor, or both the first propulsor and the second propulsor, and
wherein a first direction of the single throttle lever in the third degree of freedom selects only the first propulsor for control, a second direction of the single throttle lever in the third degree of freedom selects only the second propulsor for control, and a neutral position of the single throttle lever in the third degree of freedom selects both the first propulsor and the second propulsor for control.

14. A turbine engine control system for a propulsion system, including a first propulsor and a second propulsor that is separate from the first propulsor, the turbine engine control system comprising:
a single throttle lever having at least two degrees of freedom including a first degree of freedom and a second degree of freedom;
a first controller operatively coupled to the first propulsor, the first controller receiving position inputs from the single throttle lever and controlling the first propulsor accordingly;
a second controller operatively coupled to the second propulsor to control the second propulsor; and
a data communication bus coupling the first controller and the second controller to transmit a signal indicative of an operating mode of the second propulsor to the first controller,
wherein the first controller further:
receives a first position input from the single throttle lever in the first degree of freedom;
controls a thrust level split of the first propulsor and the second propulsor of the propulsion system based on the first position input from the single throttle lever;
receives a second position input from the single throttle lever in the second degree of freedom;
controls a thrust level of the first propulsor and the second propulsor based on the second position input from the single throttle lever; and
controls a pitch of a plurality of first propulsor blades of the first propulsor and a pitch of a plurality of second propulsor blades of the second propulsor based on input from the single throttle lever.

15. The turbine engine control system of claim 14, wherein a first direction of the single throttle lever in the first degree of freedom corresponds to a greater thrust level from the first propulsor and a lesser thrust level from the second propulsor, and a second direction of the single throttle lever in the first degree of freedom corresponds to a greater thrust level from the second propulsor and a lesser thrust level from the first propulsor, and
wherein a first direction of the single throttle lever in the second degree of freedom corresponds to a greater thrust level of the first propulsor and the second propulsor, and a second direction of the single throttle lever in the second degree of freedom corresponds to a lesser thrust level of the first propulsor and the second propulsor.

16. The turbine engine control system of claim 14, wherein the single throttle lever has a third degree of freedom,
wherein the first controller receives a third position input from the single throttle lever in the third degree of freedom and controls a switch between a forward thrust and a reverse thrust of the first propulsor and the second propulsor, and
wherein a first direction of the single throttle lever in the third degree of freedom selects the forward thrust for the first propulsor and the second propulsor, and a second direction of the single throttle lever in the third degree of freedom selects the reverse thrust for the first propulsor and the second propulsor.

17. (canceled)

18. A turbine engine control system for a propulsion system including a first propulsor and a second propulsor that is separate from the first propulsor, the first propulsor being a turbine engine having a turbo-engine and an electric machine, and the turbine engine control system comprising:
a single throttle lever having at least two degrees of freedom, including a first degree of freedom and a second degree of freedom;
a first controller operatively coupled to the first propulsor, the first controller receiving position inputs from the single throttle lever and controlling the first propulsor accordingly;
a second controller operatively coupled to the second propulsor to control the second propulsor; and
a data communication bus coupling the first controller and the second controller to transmit a signal indicative of an operating mode of the second propulsor to the first controller,
wherein the first controller further:
receives a first position input from the single throttle lever in the first degree of freedom;
controls a power level between the turbo-engine and the electric machine for the turbine engine based on the first position input from the single throttle lever;
receives a second position input from the single throttle lever in the second degree of freedom;
controls a thrust level of the first propulsor and the second propulsor based on the second position input from the single throttle lever; and
controls a pitch of a plurality of first propulsor blades of the first propulsor and a pitch of a plurality of second propulsor blades of the second propulsor based on input from the single throttle lever.

19. The turbine engine control system of claim 18, wherein a first direction of the single throttle lever in the first degree of freedom corresponds to a greater power level from the turbo-engine and a lesser power level from the electric machine, and a second direction of the single throttle lever in the first degree of freedom corresponds to a greater power level of the turbine engine from the electric machine and a lesser power level from the turbo-engine, and
wherein a first direction of the single throttle lever in the second degree of freedom corresponds to a forward thrust level of the first propulsor and the second propulsor, and a second direction of the single throttle lever in the second degree of freedom corresponds to a reverse thrust level of the first propulsor and the second propulsor.

20. (canceled)

21. The turbine engine control system of claim 1, wherein:
the first turbine engine further comprises a first electric machine;
the second turbine engine further comprises a second electric machine; and
the turbine engine control system further comprises a power conduit electrically coupling the first electric machine and the second electric machine.

22. The turbine engine control system of claim 21, wherein:
the first controller is configured to detect, via the data communication bus, that the second turbine engine is in a standby operating mode, and
during the standby operating mode of the second turbine engine, the first controller:
controls the second turbine engine and the second propulsor based on input from the single throttle lever,
commands the first electric machine to operate in a generator mode, and
provides electrical power from the first electric machine to the second electric machine via the power conduit, wherein the second electric machine operates in a motor mode to drive the second propulsor.

23. The turbine engine control system of claim 22, wherein the standby operating mode comprises at least one of:
a normal idling mode wherein the second turbo-engine operates at between forty-five percent and seventy percent of a nominal rotational speed;
an assisted idling mode wherein the second turbo-engine operates at between twenty percent and sixty percent of the nominal rotational speed;
a banking mode wherein a combustor of the second turbo-engine is shut down and the second turbo-engine operates at between five percent and thirty percent of the nominal rotational speed; and
a stopping mode wherein the second turbo-engine is stopped or windmilling.

24. The turbine engine control system of claim 1, wherein the turbo-engine setting includes a rotational speed of the first turbo-engine, the first propulsor setting includes at least one of a rotational speed of the first propulsor, a pitch of a plurality of first propulsor blades of the first propulsor, or a torque of the first propulsor, and the second propulsor setting includes at least one of a rotational speed of the second propulsor, a pitch of a plurality of second propulsor blades of the second propulsor, or a torque of the second propulsor.
